(19) United States
(12) Patent Application Publication
(10) Pub. No.: US 2026/0213978 A1
(43) Pub. Date: Jul. 23, 2026

(54) POWER SUPERIMPOSITION CONNECTOR, POWER DISTRIBUTION METHOD, POWER SUPERIMPOSITION CONNECTOR SYSTEM, AND POWER DISTRIBUTION SYSTEM

(71) Applicants: SUMITOMO ELECTRIC INDUSTRIES, LTD., Osaka-shi, Osaka (JP); SUMITOMO WIRING SYSTEMS, LIMITED, Yokkaichi-shi, Mie (JP); AUTONETWORKS TECHNOLOGIES, LTD., Yokkaichi-shi, Mie (JP)

(72) Inventors: Yuta MIYAGAWA, Osaka-shi (JP); Yuya TANAKA, Osaka-shi (JP)

(73) Assignees: SUMITOMO ELECTRIC INDUSTRIES, LTD., Osaka-shi, Osaka (JP); SUMITOMO WIRING SYSTEMS, LIMITED, Yokkaichi-shi, Mie (JP); AUTONETWORKS TECHNOLOGIES, LTD., Yokkaichi-shi, Mie (JP)

(21) Appl. No.: 19/140,505

(22) PCT Filed: Nov. 17, 2023
(86) PCT No.: PCT/JP2023/041517

§ 371 Date: Jun. 18, 2025

(30) Foreign Application Priority Data
Dec. 27, 2022 (JP) 2022-209658

(51) Int. Cl. H04L 25/02

(52) U.S. Cl. CPC H04L 25/02

(57) ABSTRACT

A power superimposition connector including: a housing having a first connection electrically coupled to a communication line configured to carry an electrical signal, and a second connection; and a power exchange circuit that is connected to the first connection and the second connection, is provided within the housing, and is configured to perform exchange between power superimposed on an electrical signal on the communication line and power on a power line connected to the second connection, between the first connection and the second connection.

### BACKGROUND

The present disclosure relates to a power superimposition connector, a power distribution method, a power superimposition connector system, and a power distribution system. This application claims priority based on Japanese Application No. 2022-209658 filed on Dec. 27, 2022, and incorporates by reference all of the contents of said Japanese application.

As a result of vehicles becoming more electronic, modern automobiles are equipped with a significant number of Electronic Control Units (ECUs). All of these ECUs are programmable electronic circuit devices and need to work together. For this reason, these ECUs are capable of communicating with each other via an in-vehicle network, and operate under the control of an electronic circuit device that performs overall control, such as a Central-Electric Control Unit (C-ECU).

In addition to power source lines that supply power to each ECU, the vehicle must also be connected to communication lines for communication between ECUs and with the C-ECU. Such communication lines and the like are provided inside the vehicle as a wire harness. However, as the number of ECUs mounted in a vehicle increases, the overall length of the wire harness increases, causing problems such as compressing the space inside the vehicle and increasing the weight of the vehicle.

One method for solving these problems is the technology described in JP 2017-046356A. The technology described in JP 2017-046356A is a technology in which DC power is superimposed on a communication line for transmitting and receiving data. Such technology is generally called Power over Data Line (PoDL). PoDL has the advantage of eliminating the need for a separate power source line.

### SUMMARY

A power superimposition connector according to a first aspect of this disclosure includes: a housing having a first connection portion electrically coupled to a communication line configured to carry an electrical signal, and a second connection portion; and a power exchange circuit that is connected to the first connection portion and the second connection portion, is provided within the housing, and is configured to perform exchange between power superimposed on an electrical signal on the communication line and power on a power line connected to the second connection portion, between the first connection portion and the second connection portion.

This disclosure can be realized not only as such a characteristic power superimposition connector, a power superimposition connector system, a method for adjusting power supply, and a method for supplying power, but also as a design method in which such characteristic processing is a step, or as a program for causing a computer to execute such steps. This disclosure can also be realized as a semiconductor integrated circuit that realizes part or all of the power superimposition connector, or as a power superimposition connector system that includes a power superimposition connector device.

### BRIEF DESCRIPTION OF THE DRAWINGS

FIG. 1 is a block diagram showing a schematic configuration of an in-vehicle system using a PoDL connector according to a first embodiment of the present disclosure.

FIG. 2 is a circuit diagram showing a schematic configuration of a PoDL connector used in the first embodiment of the present disclosure.

FIG. 3 is a circuit diagram showing a schematic configuration of a PoDL circuit that receives supply of power.

FIG. 4 is a circuit diagram showing a schematic configuration of a PoDL circuit that supplies power.

FIG. 5 is a block diagram showing a schematic configuration of another in-vehicle system using the PoDL connector according to the first embodiment of the present disclosure.

FIG. 6 is a block diagram showing a schematic configuration of yet another in-vehicle system using the PoDL connector according to the first embodiment of the present disclosure.

FIG. 7 is a diagram showing an example of a usage mode of the PoDL connector according to the present disclosure.

FIG. 8 is a diagram showing another example of a usage mode of the PoDL connector according to the present disclosure.

FIG. 9 is a diagram showing a schematic configuration of an in-vehicle system using a PoDL connector according to a second embodiment and a third embodiment according to the present disclosure.

FIG. 10 is a block diagram showing a schematic configuration of a PoDL connector according to the second embodiment of the present disclosure.

FIG. 11 is a diagram showing an example of a usage mode of the PoDL connector according to the second embodiment.

FIG. 12 is a block diagram showing a schematic configuration of a PoDL connector according to the third embodiment of the present disclosure.

FIG. 13 is a diagram showing an example of a usage mode of the PoDL connector according to the second embodiment.

FIG. 14 is a diagram showing an example of a usage mode of the PoDL connector according to the second embodiment.

FIG. 15 is a circuit block diagram showing a schematic configuration of a PoDL connector according to the second embodiment.

FIG. 16 is a diagram showing an example of a usage mode of the PoDL connector according to the second embodiment.

FIG. 17 is a diagram showing an example of a usage mode of a PoDL connector serving as a redundant power source according to the third embodiment of the present disclosure.

FIG. 18 is a diagram showing another example of a usage mode of a PoDL connector serving as a redundant power source.

FIG. 19 is a diagram showing yet another example of a usage mode of a PoDL connector serving as a redundant power source.

FIG. 20 is a diagram showing an example of a usage mode a PoDL connector serving as a redundant power source.

FIG. 21 is a diagram showing another example of a usage mode of a PoDL connector serving as a redundant power source.

FIG. 22 is a diagram showing yet another example of a usage mode of a PoDL connector serving as a redundant power source.

FIG. 23 is a diagram showing an example of a usage mode of a PoDL connector serving as a redundant power source.

FIG. 24 is a diagram showing another example of a usage mode of a PoDL connector serving as a redundant power source.

FIG. 25 is a circuit diagram showing a schematic configuration of a PoDL connector used in a fourth embodiment of the present disclosure.

### DETAILED DESCRIPTION OF EMBODIMENTS

### Problem to be Solved by the Disclosure

There is an upper limit to current that can be supplied from one PoDL circuit and an ECU including a PoDL circuit. For this reason, when an attempt is made to develop an in-vehicle system using this technology, the degree of freedom in design may be limited, such as the power required by a specific ECU not being able to be supplied by PoDL in some cases when an attempt is made to use that ECU.

An object of the present disclosure is to provide a power superimposition connector, a power distribution method, a power superimposition connector system, and a power distribution system that can increase the degree of freedom in design in an in-vehicle system that uses PoDL.

### Advantageous Effects of the Disclosure

According to the present disclosure, it is possible to provide a power superimposition connector, a power distribution method, a power superimposition connector system, and a power distribution system.

### Description of Embodiments of the Present Disclosure

In the following description and in the drawings, identical components are denoted by identical reference numbers. Accordingly, detailed description thereof will not be repeated. Note that at least some of the embodiments described below may be combined as appropriate.

(1) A power superimposition connector according to a first aspect of the present disclosure includes: a housing having a first connection portion electrically coupled to a communication line configured to carry an electrical signal, and a second connection portion; and a power exchange circuit that is connected to the first connection portion and the second connection portion, is provided within the housing, and is configured to perform exchange between power superimposed on an electrical signal on the communication line and power on a power line connected to the second connection portion, between the first connection portion and the second connection portion. By using this power superimposition connector, when superimposing power on a communication line carrying an electrical signal to distribute the power to each circuit, power can be easily branched, merged, distributed, and the like via the communication line in an in-vehicle system or the like that includes a plurality of electronic circuit devices. As a result, it is possible to increase the degree of freedom in design in an in-vehicle system that uses PoDL.

(2) In (1) above, the power superimposed on the electrical signal on the communication line may be DC power. This configuration can increase the degree of freedom in design in an in-vehicle system or the like that includes a plurality of electronic circuit devices using a simple circuit.

(3) In (2) above, the power exchange circuit may include a low pass filter. With this configuration, in an in-vehicle system or the like including a plurality of electronic circuit devices, DC power can be extracted from a signal carried by a communication line and output to a power line, thereby increasing the degree of freedom in design.

(4) In (2) above, the power exchange circuit may include: a low pass filter having a first connection terminal connected to the first connection portion, and a second connection terminal; and a voltage conversion circuit provided between the second connection terminal of the low pass filter and the second connection portion. This configuration makes it possible to easily exchange power even between communication lines on which DC power of different voltages is superimposed in an in-vehicle system or the like that includes a plurality of electronic circuit devices, thereby increasing the degree of freedom in design.

(5) In any one of (1) to (4) above, the first connection portion may include: a first connection terminal and a second connection terminal each electrically coupled to the communication line; and an internal communication line provided within the housing, the internal communication line connecting the first connection terminal and the second connection terminal, and the power exchange circuit may be provided between the internal communication line and the second connection portion. This configuration can increase the degree of freedom in design in an in-vehicle system or the like that includes a plurality of electronic circuit devices.

(6) A power distribution method according to a second aspect of this disclosure is a power distribution method for distributing power using a power superimposition connector including: a housing having a first connection portion and a second connection portion each electrically coupled to a communication line configured to carry an electrical signal on which DC power is superimposed; and a power exchange circuit that is connected to the first connection portion and the second connection portion, is provided within the housing, and is configured to perform exchange of power between the first connection portion and the second connection portion, the method including: a step of connecting the first connection portion to a first communication line; a step of connecting the second connection portion to a power line different from the first communication line; a step of extracting the power from the communication line via the first connection portion; and a step of exchanging, using the power exchange circuit, the power extracted in the step of extracting of the power with power superimposed on an electrical signal on the power line via the second connection portion. This configuration makes it possible to change the power supply destination and power supply source between the first electronic circuit device and the second electronic circuit device, thereby increasing the degree of freedom in design, in an in-vehicle system or the like including a plurality of electronic circuit devices.

(7) A power superimposition connector system according to a third aspect of the present disclosure includes a first power superimposition connector according to any one of (1) to (5) above, a second power superimposition connector according to any one of (1) to (5) above, and a power line connected to the second connection portion of the first power superimposition connector and the second connection portion of the second power superimposition connector. This configuration makes it possible to, in an in-vehicle system or the like that includes a plurality of electronic circuit devices, perform branching, merging, distribution, and the like of power via a communication line between the electronic circuit devices, thereby increasing the degree of freedom in design.

(8) In (7) above, the first connection portion of the first power superimposition connector may be connected to a first communication line carrying an electrical signal on which DC power is superimposed, branch at least a portion of the DC power from the first communication line, and output the branched power to the power line, and the first connection portion of the second power superimposition connector may be connected to a second communication line carrying an electrical signal on which DC power is superimposed, receive the branched power from the first power superimposition connector via the power line, and superimpose the branched power on the electrical signal on the second communication line. This configuration makes it possible to, when power is supplied via the first communication line between the electronic circuits, easily perform branching of the supplied power, thereby increasing the degree of freedom in design in an in-vehicle system or the like including a plurality of electronic circuit devices.

(9) In (8) above, at least one of the first communication line and the second communication line may be a network. With this configuration, in an in-vehicle system or the like including a plurality of electronic circuit devices, it is easier to branch power supplied via a network and supply the branched power to any electronic circuit, or to branch power supplied from an electronic circuit to the network and supply power from the network to any other electronic circuit device connected to the network, thereby increasing the degree of freedom in design.

(10) In (8) above, at least one of the first communication line and the second communication line may be a power source line. With this configuration, in an in-vehicle system or the like that includes a plurality of electronic circuit devices, for electronic circuit devices that cannot receive power directly from the power source line, it is possible to supply power to the electronic circuit by branching power from the power source line and superimposing the branched power on the electrical signal on the communication line. As a result, the degree of freedom in design can be increased.

(11) In (8) above, the first communication line is connected to a first electronic circuit and a second electronic circuit, and the second communication line is connected to the first electronic circuit and a third electronic circuit that is different from both the first electronic circuit and the second electronic circuit. With this configuration, in an in-vehicle system including a plurality of electronic circuit devices, a portion of the power supplied from the first electronic circuit to the second electronic circuit can be supplied also to the third electronic circuit. For this reason, even in a case where power can be supplied from the first electronic circuit via the first communication line but power cannot be supplied via the second communication line, it becomes easy to branch and supply the power supplied from the first electronic circuit via the first communication line to the third electronic circuit connected to the second communication line. As a result, it is possible to increase the degree of freedom in designing an in-vehicle system or the like.

(12) In (8) above, the first communication line connects a first electronic circuit and a second electronic circuit, and the second communication line is connected to a third electronic circuit and a fourth electronic circuit that are both different from both the first electronic circuit and the second electronic circuit. With this configuration, in an in-vehicle system or the like including a plurality of electronic circuit devices, it is possible to branch the power supply between communication lines between different combinations of electronic circuits. As a result, it is possible to easily distribute the supplied power between different pairs of electronic circuits, thereby increasing the degree of freedom in design.

(13) In (8) above, the second communication line may be a communication line in which, other than the branched power superimposed by the second power superimposition connector, DC power is not superimposed on an electrical signal. With this configuration, when an electronic circuit that can receive supply of power via a communication line is disposed in place of an electronic circuit that has not previously received supply of power via a communication line, power can be supplied to the electronic circuit via the communication line without the need for power source wiring for the new electronic circuit. In addition, if the power supplied through the existing power source wiring is insufficient for the operation of the new electronic circuit, the shortage of power can be made up for by supplying power via the communication line. As a result, in an in-vehicle system or the like including a plurality of electronic circuit devices, the degree of freedom in the arrangement of electronic circuits is increased, and the degree of freedom in designing the in-vehicle device or the like can be increased.

(14) A power distribution system according to a fourth aspect of this disclosure is a power distribution system including a first power superimposition connector system and a second power superimposition connector system according to (7) above, in which the first power superimposition connector system is connected to a first communication line and a second communication line on which DC power can be superimposed, and the second power superimposition connector system is connected between a third communication line that is different from both the first communication line and the second communication line, and the second communication line. With this configuration, it is possible to supply power to the same second communication line from different first and third communication lines, or to supply power to both the first and third communication lines from the second communication line. As a result, it becomes possible to supply a large amount of power to another electronic circuit device via the second communication line, or to supply power to a plurality of electronic circuit devices from a device connected to the second communication line, thereby increasing the degree of freedom in designing an in-vehicle device or the like.

(15) In (14) above, the first power superimposition connector system may branch a portion of the DC power superimposed on the electrical signal on the first communication line and superimpose the branched power on the electrical signal on the second communication line, and the second power superimposition connector system may branch a portion of the DC power superimposed on the electrical signal on the third communication line and superimpose the branched power on the electrical signal on the second communication line. With this configuration, power can be supplied from the first communication line and the third communication line to the same second communication line. As a result, it is possible to supply a large amount of power to another electronic circuit device via the second communication line, thereby increasing the degree of freedom in designing an in-vehicle device or the like.

(16) In (14) above, the first power superimposition connector system may branch a portion of the DC power superimposed on the electrical signal on the second communication line and superimpose the branched power on the electrical signal on the first communication line, and the second power superimposition connector system may branch a portion of the DC power superimposed on the electrical signal on the second communication line and superimpose the branched power on the electrical signal on the third communication line. With this configuration, when a large amount of power can be supplied from the electronic circuit device connected to the second communication line, the power can be supplied to another electronic circuit device connected to the first communication line or the third communication line. As a result, even when a plurality of new electronic circuit devices consuming large amounts of power are introduced accompanying a change in the design of, for example, an in-vehicle system, it is possible to supply the necessary power without strengthening the power supply path. As a result, it is possible to increase the degree of freedom in designing an in-vehicle system or the like.

(17) A power superimposition connector system according to a fifth aspect of this disclosure is a power superimposition connector system including a first power superimposition connector and a second power superimposition connector according to (4) above, in which the voltage conversion circuit of the first power superimposition connector includes a step-up circuit for stepping up from a predetermined first voltage to a second voltage that is higher than the first voltage, and the voltage conversion circuit of the second power superimposition connector includes a step-down circuit for stepping down from the second voltage to a third voltage that is lower than the second voltage. With this configuration, the movement of power between the communication lines is accomplished at a high voltage. As a result, compared to when power is supplied at a lower voltage, the current can be reduced even when the same power is supplied. As a result, the amount of power that can be supplied to each electronic circuit device can be kept sufficient while suppressing heat generation. Accordingly, it is possible to increase the degree of freedom in designing an in-vehicle system or the like.

(18) In (17) above, the third voltage may be equal to the first voltage. With this configuration, movement of power between the communication lines is performed at a high voltage, thereby reducing current loss and suppressing heat generation compared to when power is branched at a low voltage. As a result, power loss can be reduced, and the power required for the operation of each electronic circuit device can be supplied at an appropriate voltage. Accordingly, it is possible to increase the degree of freedom in designing an in-vehicle system or the like.

(19) In (17) above, the third voltage is different from the first voltage. With this configuration, movement of power between the communication lines is performed at a high voltage, and therefore power loss can be reduced. In addition, each electronic circuit can be supplied with power at a voltage necessary for the proper operation of the electronic circuit that is the power supply destination. Accordingly, it is possible to increase the degree of freedom in designing an in-vehicle system or the like.

(20) A power distribution system according to a sixth aspect of this disclosure is a power distribution system including a first power superimposition connector system including a first power superimposition connector and a second power superimposition connector according to any one of (1) to (5) above, and a second power superimposition connector system including a first power superimposition connector and a second power superimposition connector according to any one of (1) to (5) above, in which in both the first power superimposition connector system and the second power superimposition connector system, at least one of the first power superimposition connector and the second power superimposition connector has the configuration according to (4) above, the first power superimposition connector of the first power superimposition connector system is connected to a first communication line, the second power superimposition connector of the first power superimposition connector system is connected to a second communication line different from the first communication line, the first power superimposition connector of the second power superimposition connector system is connected to a third communication line different from the first communication line and the second communication line, the second power superimposition connector of the second power superimposition connector system is connected to the second communication line, the first power superimposition connector system branches DC power of a first voltage that is superimposed on an electrical signal on the first communication line, converts the branched DC power to a second voltage, and superimposes the result on an electrical signal on the second communication line, and the second power superimposition connector system branches DC power of a third voltage that is superimposed on an electrical signal on the third communication line, converts the branched DC power to the second voltage, and superimposes the result on the electrical signal on the second communication line. With this configuration, power can be branched from both the first communication line and the third communication line and superimposed on an electrical signal on the second communication line. All of the superimposed voltages are the second voltage, and by matching this second voltage with a voltage for operating an electronic circuit device that is connected to the second communication line and receives supply of power, power from a plurality of power sources can be combined and supplied to the electronic circuit device on the second communication line. As a result, even when an electronic circuit device consuming a large amount of power is connected to the second communication line, it is not necessary to strengthen the power source circuit. Accordingly, it is possible to increase the degree of freedom in designing an in-vehicle system or the like.

(21) In (20) above, the first voltage and the third voltage are different from each other. With this configuration, even when two power sources supplying different voltages are connected to the first and third communication lines, the power from them can be converted to the second voltage and supplied to the second communication line. As a result, even when an electronic circuit device consuming a large amount of power is connected to the second communication line, it is not necessary to strengthen the power source circuit. Accordingly, it is possible to increase the degree of freedom in designing an in-vehicle system or the like.

(22) In (20) above, the first voltage and the third voltage are equal to each other. For this reason, the first power superimposition connector system and the second power superimposition connector system can have the same configuration. In addition, even when an electronic circuit device that consumes a large amount of power is connected to the second communication line, there is no need to strengthen the power source circuit. Accordingly, it is possible to increase the degree of freedom in designing an in-vehicle system or the like.

(23) A power distribution system according to a seventh aspect of this disclosure is a power distribution system including a first power superimposition connector system including a first power superimposition connector and a second power superimposition connector according to any one of (1) to (5) above, and a second power superimposition connector system including a first power superimposition connector and a second power superimposition connector according to any one of (1) to (5) above, in which in both the first power superimposition connector system and the second power superimposition connector system, at least one of the first power superimposition connector and the second power superimposition connector has the configuration described in (4) above, the first power superimposition connector of the first power superimposition connector system is connected to a first communication line, the second power superimposition connector of the first power superimposition connector system is connected to a second communication line different from the first communication line, the first power superimposition connector of the second power superimposition connector system is connected to the first communication line, the second power superimposition connector of the second power superimposition connector system is connected to a third communication line different from the first communication line and the second communication line, the first power superimposition connector system branches DC power of a first voltage that is superimposed on an electrical signal on the first communication line, converts the branched DC power to a second voltage, and superimposes the result on an electrical signal on the second communication line, and the second power superimposition connector system branches DC power of the first voltage that is superimposed on the electrical signal on the first communication line, converts the branched DC power to a third voltage, and superimposes the result on an electrical signal on the third communication line. With this configuration, the power superimposed on the electrical signal on the first communication line is branched into power of the second voltage and power of the third voltage and supplied to other electronic circuit devices via the second communication line and the third communication line, respectively. The voltage of the electronic circuit device connected to the second communication line and the third communication line is not limited to a specific voltage. As a result, it is possible to increase the degree of freedom in designing an in-vehicle system or the like.

(24) In (23) above, the second voltage and the third voltage are different from each other. With this configuration, the power superimposed on the electrical signal on the first communication line is branched into powers having different voltages and supplied to the other electronic circuit devices via the second communication line and the third communication line, respectively. There is no need to unify the voltages of the electronic circuit devices connected to the second communication line and the third communication line, which increases the degree of freedom in designing an in-vehicle system or the like.

(25) In (23) above, the second voltage and the third voltage are equal to each other. With this configuration, the power superimposed on the electrical signal on the first communication line is branched into powers of equal voltages and supplied to the other electronic circuit devices via the second communication line and the third communication line, respectively. If the voltages of the electronic circuit devices connected to the second communication line and the third communication line can be unified, and for example, if the electronic circuit device complies with a certain standard, there is no need to give particular consideration to the power source voltage. As a result, it is possible to increase the degree of freedom in designing an in-vehicle system or the like.

(26) In any one of (14) to (24) above, a first electronic circuit device connected to the first communication line, and a second electronic circuit device connected to the first communication line may be further included. The power supplied from one of the first electronic circuit device and the second electronic circuit device to another communication path via the first communication path can be branched and supplied to the first electronic circuit device or the second electronic circuit device, or supply of power can be received from the other communication path in one of the first electronic circuit device and the second electronic circuit device. This reduces the need to give particular consideration to the power consumption of the first electronic circuit device and the second electronic circuit device, or to give consideration to the power consumption of other electronic circuit devices, thereby increasing the degree of freedom in designing an in-vehicle system or the like.

### Details of Embodiments of the Present Disclosure

Specific examples of a power superimposition connector, a power distribution method, a power superimposition connector system, and a power distribution system according to embodiments of the present disclosure will be described below with reference to the drawings. Note that the present disclosure is not limited to these examples, but is indicated by the claims, and all modifications within the meaning and scope equivalent to the claims are intended to be encompassed therein. For example, in the following description, a controller area network (CAN) is given as an in-vehicle network. However, this disclosure is not limited to such embodiments. The in-vehicle network is not limited to CAN, but may be any of CAN with Flexible Data rate (CAN FD), CAN XL, Local Interconnect Network (LIN), Clock Extension Peripheral Interface (CXPI), Media Oriented Systems Transport (MOST), FlexRay, 100BASE-T1, or the like. In addition, data signals are generally differential signals and require two communication lines. However, in the following description, in order to avoid complicating the drawings, each communication line is represented by a single line. Although a set of terminals for a communication line is actually formed by two terminals, they are represented by a single rectangle in the drawings.

### 1. First Embodiment

### 1 -1 First Usage Mode (Power Supply Between Communication Lines)

A PoDL connector according to this disclosure can be used to supply power from a device that generally supplies power, such as a C-ECU or an ECU with a heterogeneous I/F (Interface), to another device using PoDL.

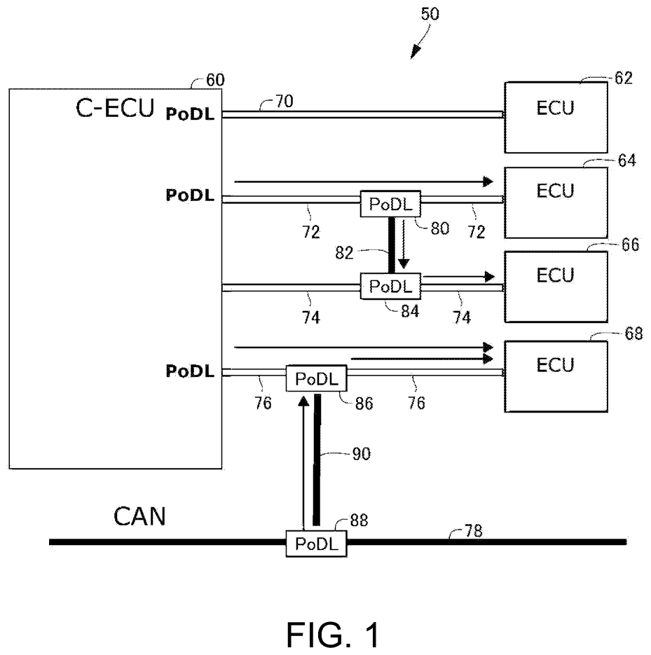

FIG. 1 shows an in-vehicle system 50 that uses a PoDL connector according to a first embodiment of this disclosure in a first usage mode. Referring to FIG. 1, the in-vehicle system 50 includes a C-ECU 60, an ECU 62, an ECU 64, an ECU 66, an ECU 68, and a CAN 78. The C-ECU 60 is connected to the ECU 62, the ECU 64, the ECU 66, and the ECU 68 via a communication line 70, a communication line 72, a communication line 74, and a communication line 76, respectively. Among these communication lines, the communication line 70, the communication line 72, and the communication line 76 are communication lines that carry data signals, which are electrical signals on which DC power is superimposed. PoDL circuits for power supply, which will be described later, are provided in portions of the C-ECU 60 that are connected to these communication lines. In FIG. 1, the portion where this PoDL circuit is provided is marked “PoDL”. The same applies to the subsequent drawings as well. Also, in this embodiment, PoDL circuits for receiving power, which will be described later, are provided at portions where the ECU 62, the ECU 64, the ECU 66, and the ECU 68 are connected to the respective communication lines.

A PoDL connector 80 and a PoDL connector 84 are inserted into the communication line 72 and the communication line 74, respectively. The PoDL connector 80 and the PoDL connector 84 are connected by a power line 82. A PoDL connector 86 and a PoDL connector 88 are inserted into the communication line 76 and the CAN 78, respectively. The PoDL connector 86 and the PoDL connector 88 are connected by a power line 90. These are an example of a power superimposition connector system according to this disclosure.

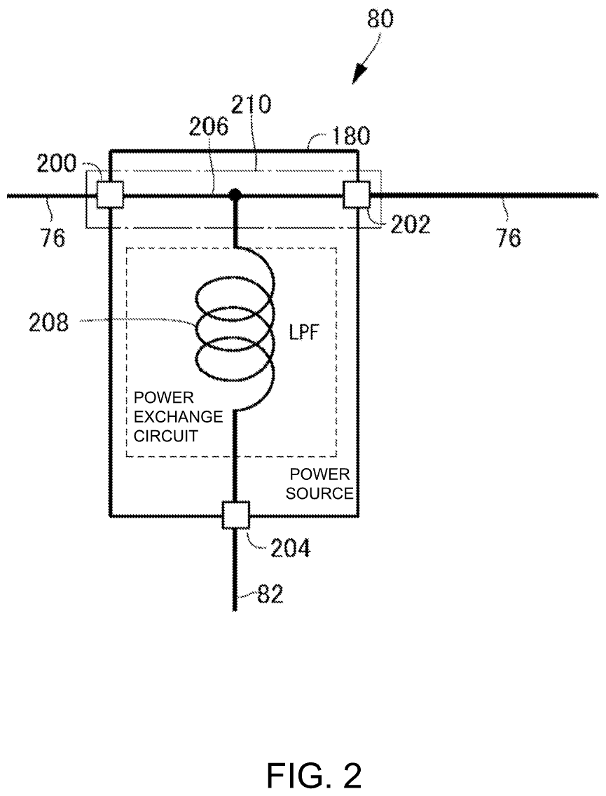

FIG. 2 shows a configuration of the PoDL connector 80. Referring to FIG. 2, the PoDL connector 80 includes a housing 180. The housing 180 is provided with a first connection portion 210 (first connection) that is electrically coupled to the communication line 76 and is provided to insert the housing 180 into the communication line 76, and a second connection portion 204 (second connection) that is electrically coupled to the power line 82. The first connection portion 210 includes a connection terminal 200 and a connection terminal 202 that are respectively electrically connected to the communication line 76 on both sides.

The PoDL connector 80 includes an internal communication line 206 provided for connecting the connection terminal 200 and the connection terminal 202 within the housing 180, and a coil 208, which is a low-pass filter that is provided between the internal communication line 206 and the second connection portion 204, extracts DC power from a signal carried by the internal communication line 206, and outputs the extracted DC power to the power line 82, thereby performing power exchange between the internal communication line 206 and the power line 82. Extracting DC power from the data signal carried by the internal communication line 206 and outputting the extracted DC power to the power line 82 is an example of exchanging the power superimposed on the electrical signal on the communication line and the power on the power line connected to the second connection portion. A low pass filter is an example of a power exchange circuit.

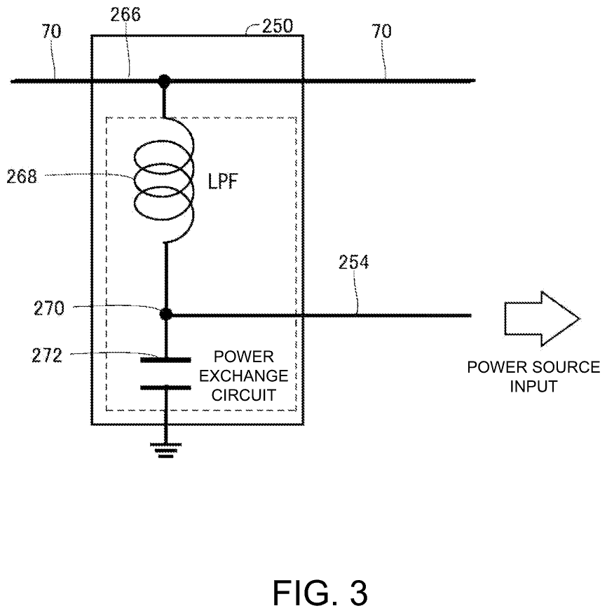

Note that in this specification, “inserting” a PoDL connector or the internal communication line 206 or the like into a communication line does not only mean dividing the communication line 76 into two as shown in FIG. 2 and connecting both to terminals such as the connection terminal 200 and the connection terminal 202, thereby making an internal communication line such as the internal communication line 206 part of the communication line 76, but also includes directly and electrically coupling the communication line 76 inside the PoDL connector without dividing the communication line 76, as in the fourth embodiment described below. In addition, in FIG. 3 and subsequent drawings, terminals such as the connection terminal 200, the connection terminal 202, and the second connection portion 204 are not shown in the drawings in order to avoid complicating the drawings. Note that when the internal communication line is constituted by two signal lines for communicating differential signals, the configuration shown in FIG. 2 may be applied to each of the signal lines.

FIG. 3 shows a configuration of a PoDL circuit 250 for power source input provided in, for example, the ECU 62. Referring to FIG. 3, the PoDL circuit 250 includes an internal communication line 266 inserted into the communication line 70, and a coil 268 and a capacitor 272, which constitute a low-pass filter connected between the internal communication line 266, which is an example of a power exchange circuit, and a ground potential. A node 270, which is a contact point between the coil 268 and the capacitor 272, which constitute a low pass filter, is connected to a power source line 254 of the ECU 62. The low pass filter is for power exchange between the internal communication line 266 and the power source line 254.

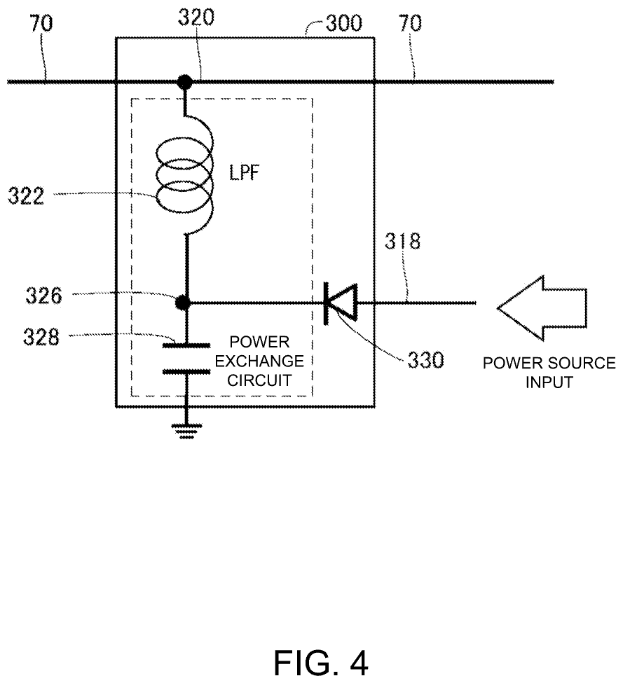

FIG. 4 shows a configuration of a PoDL circuit 300 for supplying power, which is provided in, for example, the C-ECU 60. Referring to FIG. 4, the PoDL circuit 300 includes an internal communication line 320 inserted into the communication line 70, and a coil 322 and a capacitor 328, which constitute a low pass filter connected between the internal communication line 320, which is an example of a power exchange circuit, and a ground potential. The PoDL circuit 300 further includes a diode 330 inserted between a power source line 318 from the power source of the C-ECU 60 and a node 326 that is a connection point between the coil 322 and the capacitor 328, which constitute a low pass filter, such that the direction from the power source line 318 to the node 326 is a forward direction. The low pass filter and the diode 330 are for power exchange between the power source line 318 and the internal communication line 320.

The DC power from the power source of the C-ECU 60 is superimposed on the data signal on the communication line 70 via the diode 330 and the low-pass filter.

For example, a case is envisioned in which neither the PoDL connector 80 nor the PoDL connector 84 is present in the example shown in FIG. 1. The ECU 66 needs to be supplied with power from a power source independent of the C-ECU 60. However, by providing the PoDL connector 80 and the PoDL connector 84, power can be supplied to the ECU 66 by PoDL via the path of the C-ECU 60, the communication line 72, the power line 82, the PoDL connector 84, and the communication line 74. As a result, it is no longer necessary to provide an independent power supply line for the ECU 66, and the overall length of the wire harness can be prevented from increasing.

Similarly, in FIG. 1, it may become necessary to use a device that consumes a large amount of power as the ECU 68, and power supply from the C-ECU 60 via the PoDL may become insufficient. In such a case, replacing the C-ECU 60 with another one would increase costs and would not be reasonable. By superimposing the DC power on the data signal on the CAN 78, additional power can be supplied from the CAN 78 to the ECU 68 via the PoDL connector 88, the power line 90, and the communication line 76. As a result, the power required for the ECU 68 can be ensured, and there is no need to modify the C-ECU 60 or to install an additional power supply line.

### 1-2 Second Usage Mode (Power Supply Between Communication Lines)

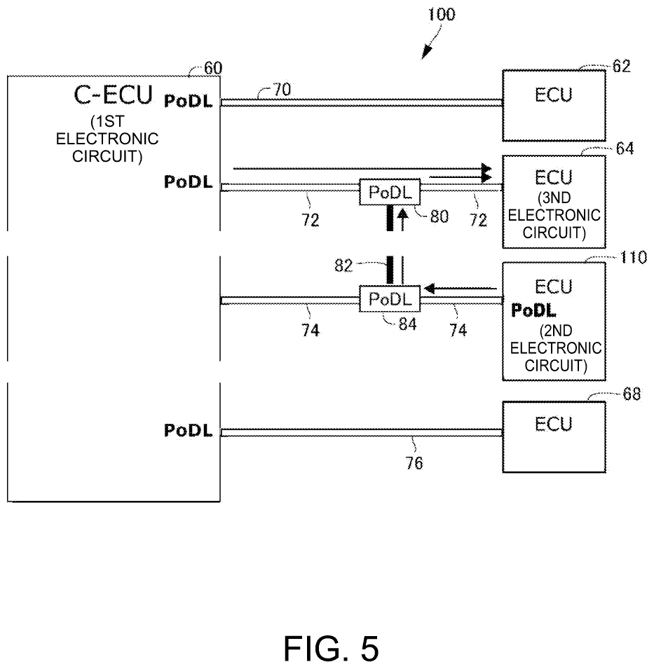

FIG. 5 is a block diagram showing a schematic configuration of another in-vehicle system using the PoDL connector according to the first embodiment of this disclosure. Referring to FIG. 5, the hardware configuration of the in vehicle system 100 according to this usage mode is similar to that of the in-vehicle system 50 shown in FIG. 1, except that an ECU 110 is connected to the communication line 74 instead of the ECU 66 shown in FIG. 1. The ECU 110 has a function of supplying power to other devices via PoDL.

By using the ECU 110 having power supply capability instead of the ECU 66 shown in FIG. 1, in addition to power from the C-ECU 60, power can be supplied to the ECU 64 from the ECU 110 via the communication line 74, the PoDL connector 84, the power line 82, the PoDL connector 80, and the communication line 72. As a result, it is possible to replace the ECU 64 with a more powerful one without installing a new power supply line.

### 1-3 Third Usage Mode (Power Supply Between Communication Line and Power Source Line)

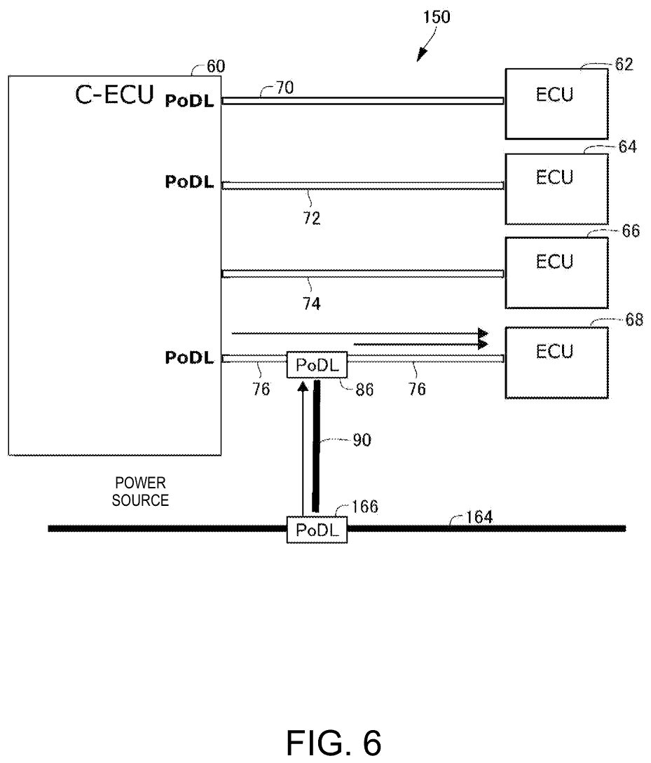

FIG. 6 shows an in-vehicle system that is a third usage mode of the PoDL connector according to the first embodiment. Referring to FIG. 6, an in-vehicle system 150 according to a third usage mode is obtained by removing the PoDL connector 80, the PoDL connector 84, and the PoDL connector 88 from the in-vehicle system 50 shown in FIG. 1, and supplying additional power to the ECU 68 from a power source line 164 instead of from the CAN 78. A PoDL connector 166 is provided on the power source line 164. A third terminal of the PoDL connector 166 is connected to a third terminal of the PoDL connector 86 by the power line 90.

With this configuration, in addition to the power from the C-ECU 60, additional power is supplied to the ECU 68 from the power source line 164 via the PoDL connector 166, the power line 90, the PoDL connector 86, and the communication line 76. It is possible to replace the ECU 68 with a more powerful one that consumes more power without changing other configurations such as the C-ECU 60. As a result, it is possible to increase the degree of freedom in designing an in-vehicle system while preventing an increase in the number of power supply lines.

### 1-4 Fourth Usage Mode (Adding/Replacing ECU)

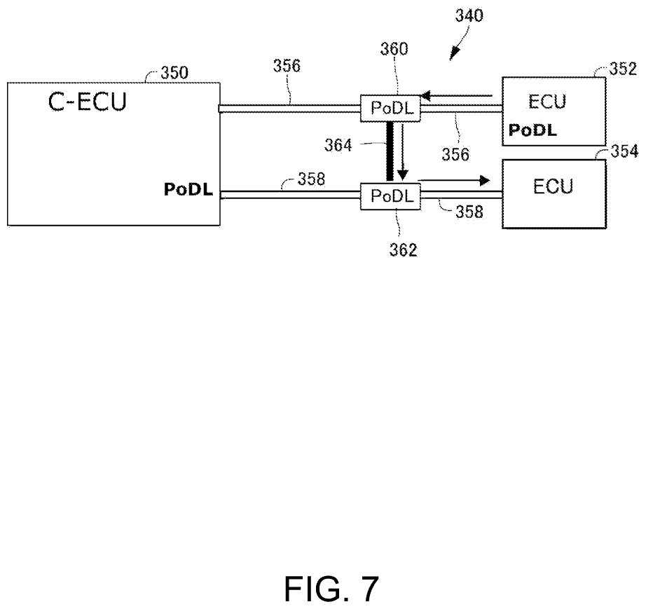

FIG. 7 shows a configuration of an in-vehicle system 340 that is a fourth usage mode of the first embodiment. Referring to FIG. 7, in this example, a C-ECU 350 is connected to two ECUs by a communication line 356 and a communication line 358, respectively. A PoDL circuit is provided inside the C-ECU 350 for the communication lines 358, but not for the communication lines 356.

In this situation, a case is considered in which an ECU 352 is newly connected to the communication line 356 and an ECU 354 is newly connected to the communication line 358 in place of the previous ones. Of these, the ECU 352 has a PoDL circuit at the connection with the communication line 356, while the ECU 354 does not. However, the ECU 354 includes a power reception circuit that extracts DC power from the signal carried by the communication line and supplies the extracted DC power to the ECU 354 itself.

In this example, it is assumed that the PoDL circuit of the C-ECU 350 cannot supply sufficient power to the ECU 354.

However, in the example shown in FIG. 7, the ECU 352 has a PoDL circuit at the connection with the communication line 356. Accordingly, in this usage mode, the PoDL connector according to the first embodiment can be used to further supply power from the ECU 352 to the ECU 354 in the following manner.

That is, a worker inserts the PoDL connector 360 into the communication line 356 as shown in FIG. 7. The worker inserts the PoDL connector 362 into the communication line 358. The worker then further connects a third terminal of the PoDL connector 360 and a third terminal of the PoDL connector 362 with a power line 364. Note that the term “worker” refers to a designer in the design stage of an in-vehicle system, and to a serviceman or other person who performs the work in the recovery stage when an in-vehicle system fails or when adding or replacing equipment.

With this configuration, power can be further supplied from the ECU 352 to the ECU 354 via the path of the communication line 356, the PoDL connector 360, the power line 364, the PoDL connector 362, and the communication line 358. As a result, when there is a power shortage due to adding and connecting a new ECU 354 to the C-ECU 350 or replacing the ECU 354 with a new one, there is an effect of being able to supply the necessary power to the ECU 354 without providing a new power supply line.

### 1-5 Fifth Usage Mode (Adding/Replacing ECU)

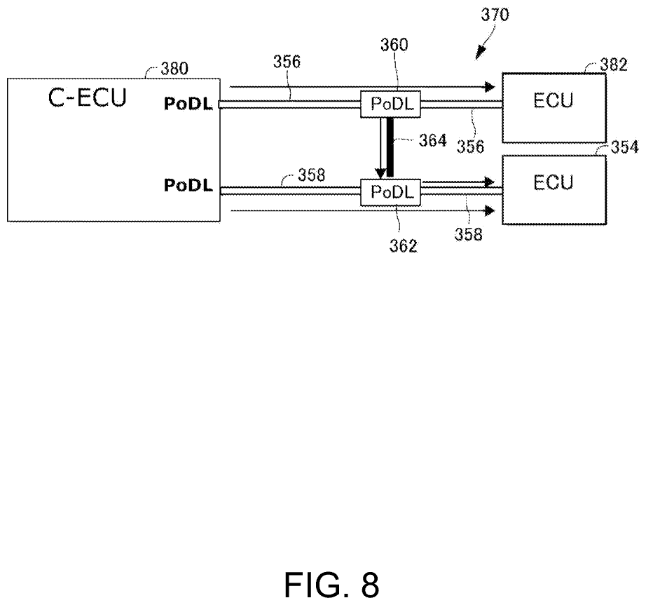

FIG. 8 shows a configuration of an in-vehicle system 370 according to a fifth usage mode of the first embodiment of this disclosure. Referring to FIG. 8, the in-vehicle system 370 is obtained by replacing the C-ECU 350 with a C-ECU 380 and replacing the ECU 352 with an ECU 382 in the in-vehicle system 340 shown in FIG. 7. The C-ECU 380 differs from the C-ECU 350 in FIG. 7 in that it has a PoDL circuit not only at the connection with the communication line 358 but also at the connection with the communication line 356. The ECU 382 differs from the ECU 352 shown in FIG. 7 in that it does not have a PoDL circuit at the connection with the communication line 356.

In the example shown in FIG. 8, similarly to the case of FIG. 7, it is assumed that the ECU 354 has difficulty in operating with only the power supplied from the C-ECU 380 via the communication line 358. In the example shown in FIG. 8, similarly to FIG. 7, an operator inserts the PoDL connector 360 and the PoDL connector 362 into the communication line 356 and the communication line 358, respectively, and connects the third terminals of both by the power line 364.

With this configuration, in addition to the power that the ECU 354 receives from the C-ECU 380 via the communication line 358, the ECU 354 can receive additional power from the C-ECU 380 via the path of the PoDL connector 360, the power line 364, the PoDL connector 362, and the communication line 358. As a result, the ECU 354 can be connected to the C-ECU 380 and be operated without the need for an additional power supply line.

### 2. Second Embodiment

### 2-1 First Usage Mode (Power Supply With Voltage Conversion Function)

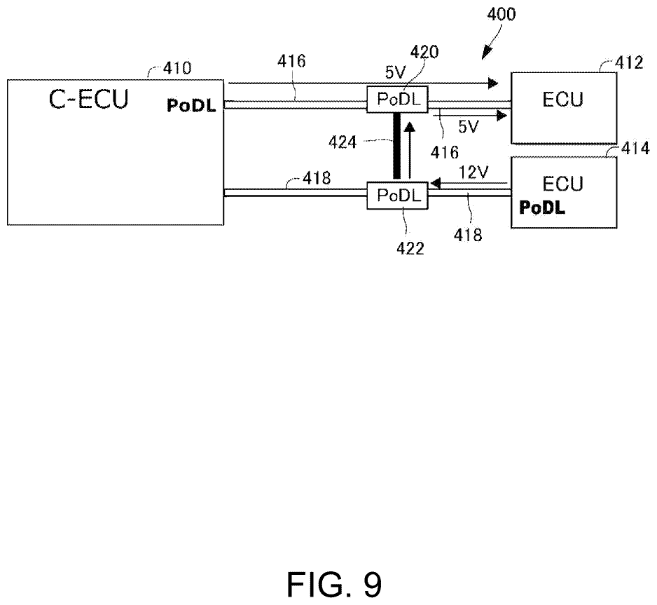

FIG. 9 shows a configuration of an in-vehicle system 400 according to a first usage mode, which uses a PoDL connector according to a second embodiment of this disclosure. Referring to FIG. 9, the in-vehicle system 400 includes a C-ECU 410, an ECU 412, and an ECU 414. The ECU 412 is connected to the C-ECU 410 via a communication line 416. The C-ECU 410 and the ECU 414 are connected to each other via a communication line 418. The PoDL circuit is provided at the connection between the C-ECU 410 and the communication line 416, and the ECU 412 receives a supply of 5-V DC power from the C-ECU 410 via PoDL. No PoDL circuit is provided at the connection between the C-ECU 410 and the communication line 418. It is assumed that the ECU 414 receives power from a power source external to the ECU 414. The ECU 414 is provided with a PoDL circuit, and is capable of outputting 12-V DC power.

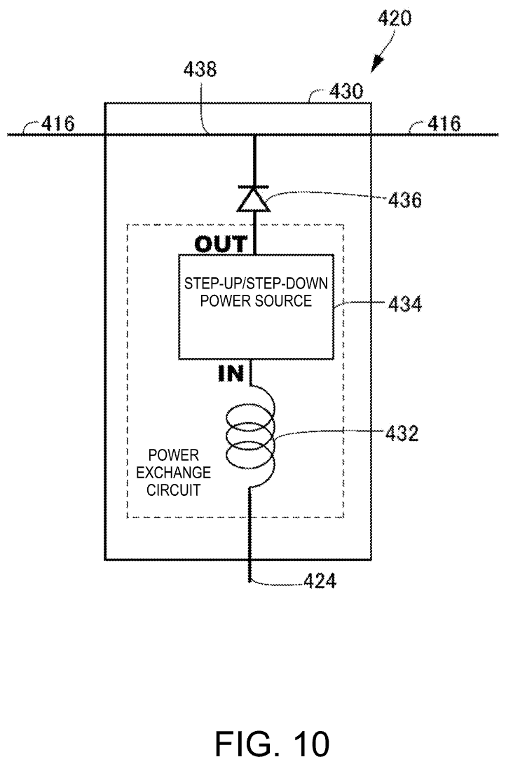

Referring to FIG. 10, a PoDL connector 420 includes a housing 430, an internal communication line 438 arranged within the housing 430 so as to be inserted into the communication line 416, a coil 432 that is a low-pass filter that is mounted on a substrate (not shown) within the housing 430 and has a first terminal connected to a power line 424, a step-up/step-down power source 434 that is a voltage conversion circuit having an input connected to a second terminal of the coil 432 that is the low-pass filter, and a diode 436 connected in the forward direction between the output of the step-up/step-down power source 434 and the internal communication line 438.

In this state, it is assumed that the supply of power received by the ECU 412 from the C-ECU 410 via the communication line 416 alone is insufficient for the ECU 412.

In such a case, the worker inserts the PoDL connector 420 according to the second embodiment of this disclosure into the communication line 416, and inserts the PoDL connector 422, which is the same as the PoDL connector 80 according to the first embodiment, into the communication line 418. The PoDL connector 420 has a voltage conversion function for converting 12-V DC power to 5-V DC power, as described below. The worker further connects the third terminal of the PoDL connector 420 and the third terminal of the PoDL connector 422 with the power line 424.

As a result, the power consumed by the ECU 412 can be supplied to the ECU 412 by the C-ECU 410 and the ECU 414 as follows. That is, the C-ECU 410 supplies a 5-V DC current to the ECU 412 via the communication line 416. The ECU 414 outputs 12-V DC power to the communication line 418.

Referring to FIG. 9, the PoDL connector 422 provided on the communication line 418 extracts a DC component from the communication line 418 and outputs the extracted DC component to the power line 424. This DC component is input to the third terminal of the PoDL connector 420.

Referring to FIG. 10, the coil 432 that is the low pass filter of the PoDL connector 420 extracts the DC component again from the power line 424 and inputs the extracted DC component to the step up/step-down power source 434. In this example, the step-up/step-down power source 434 converts the extracted DC power voltage of 12 V to 5 V and superimposes the result on the data signal on the communication line 416 via the diode 436. As a result, the ECU 412 is provided with both the 5-V DC power from the C-ECU 410 and the 5-V DC power obtained by converting the 12-V DC power from the ECU 414, via the communication line 416. Accordingly, a high performance ECU 412 that consumes a large amount of power can be used without adding a power source harness.

### 2 -2 Second Usage Mode (Power Supply With Voltage Conversion Function)

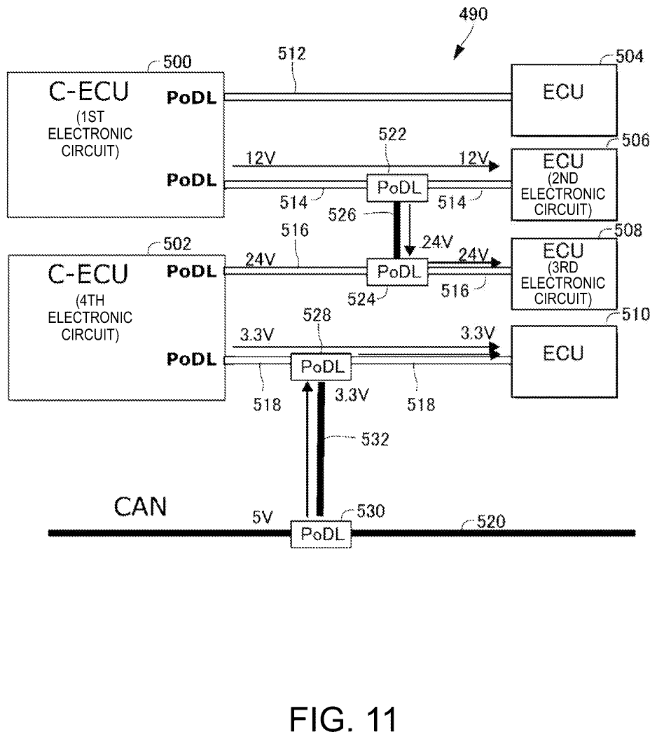

FIG. 11 shows a configuration of an in-vehicle system 490 according to a second usage mode of the PoDL connector according to the second embodiment. Referring to FIG. 11, the in-vehicle system 490 includes a C-ECU 500, a C-ECU 502, an ECU 504 and ECU 506 that are both connected to the C-ECU 500, and an ECU 508 and ECU 510 that are both connected to the C-ECU 502. The in-vehicle system 490 further includes a CAN 520, which is an in-vehicle network.

The ECU 504 and the ECU 506 are connected to the C-ECU 500 via the communication line 512 and the communication line 514, respectively. The C-ECU 500 has a PoDL circuit at each connection with each communication line. In this example, it is assumed that 12-V DC power is superimposed on the communication line 514 from the C-ECU 500. The ECU 508 and the ECU 510 are connected to the C-ECU 502 via the communication line 516 and the communication line 518, respectively. In this example, it is assumed that the C-ECU 502 superimposes 24-V DC power on the communication line 516 and 3.3-V DC power on the communication line 518. Furthermore, it is assumed that 5-V DC power is superimposed on the CAN 520.

In such a configuration, when high-performance ECUs 508 and 510 are used, a case is possible in which the required power cannot be ensured depending on the DC power that can be supplied from the C-ECU 502 to the ECU 508 and the ECU 510. The PoDL connector according to this second embodiment solves these problems as follows.

That is, the worker inserts a PoDL connector 522 having a 12-V to 24-V voltage conversion function into the communication line 514 as shown in FIG. 11. The worker inserts a PoDL connector 524 that does not have a voltage conversion function into the communication line 516. The worker further connects a third terminal of the PoDL connector 522 and a third terminal of the PoDL connector 524 with a power line 526. Meanwhile, the worker inserts a PoDL connector 528 that does not have a voltage conversion function into the communication line 518. The worker inserts a PoDL connector 530 having a 5-V to 3.3-V voltage conversion function into the CAN 520. The worker further connects a third terminal of the PoDL connector 530 and a third terminal of the PoDL connector 528 with a power line 532.

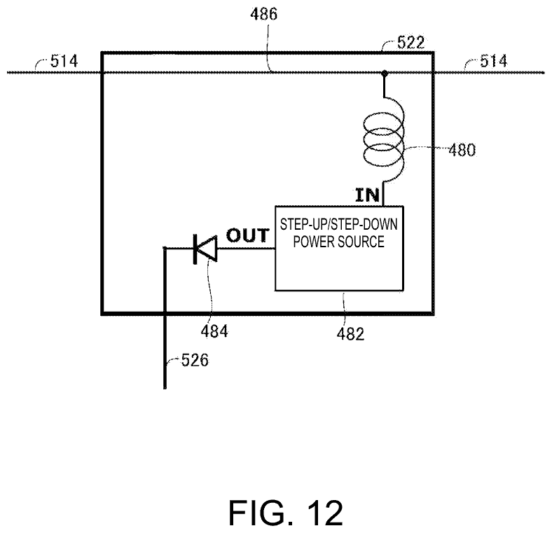

FIG. 12 shows the configuration of the PoDL connector 522. The configuration of the PoDL connector 530 is similar to this. Referring to FIG. 12, the PoDL connector 522 includes an internal communication line 486 inserted into the communication line 514, a low-pass filter 480 having a first terminal connected to the internal communication line 486, a step-up/step down power source 482 that is a voltage conversion circuit having an input terminal connected to a second terminal of the low pass filter 480, and a diode 484 connected in the forward direction between the output terminal of the step-up/step-down power source 482 and the power line 526. In this example, the step-up/step-down power source 482 has the function of stepping up 12-V DC power to 24 V. The PoDL connector 530 has a similar configuration but has the function of stepping down 5-V DC power to 3.3 V.

With this configuration, in addition to the power provided by the C-ECU 502, the ECU 508 is provided with additional power from the C-ECU 500 via the communication line 514, the PoDL connector 522, the power line 526, the PoDL connector 524, and the communication line 516. On the other hand, in addition to the power from the C-ECU 502, additional power is provided to the ECU 510 from the CAN 520 via the PoDL connector 530, the power line 532, the PoDL connector 528, and the communication line 518. As a result, it is possible to use high-performance ECUs 508 and 510 without adding a power source harness. Note that in FIG. 11, the PoDL connector 524 does not have a voltage conversion function, but the PoDL connector 524 may have a voltage conversion function. For example, if the ECU 508 operates on power with a voltage of 5 V, then it is sufficient to use a PoDL connector having a 24-V to 5-V step-down function, instead of the PoDL connector 524.

### 2-3 Third Usage Mode (Multiple-Voltage Power Supply From Power Source)

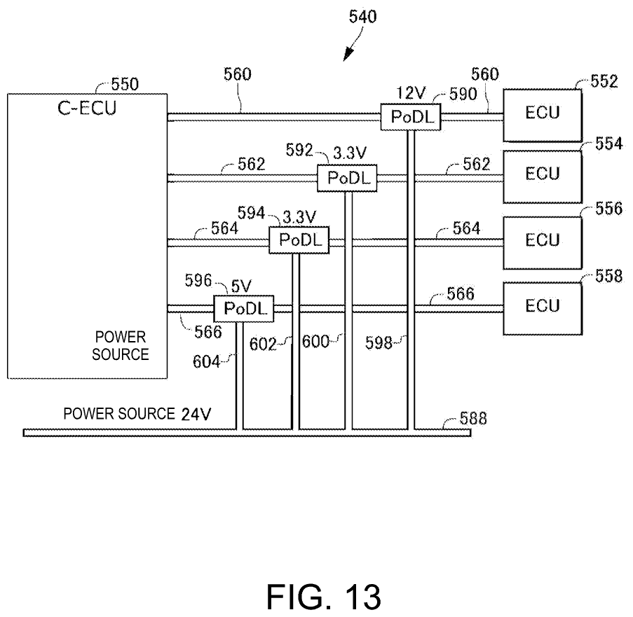

FIG. 13 shows the configuration of an in-vehicle system 540 having a function of supplying power of different voltages from a power source to a plurality of ECUs by using a plurality of PoDL connectors with voltage conversion functions according to the second embodiment. Referring to FIG. 13, the in-vehicle system 540 includes a C-ECU 550, and ECUs 552, 554, 556, and 558 connected via communication lines 560, 562, 564, and 566, respectively. The in-vehicle system 540 also includes a power source line 588 of, for example, a 24-V DC power source. If the C-ECU 550 does not have a PoDL circuit, it is necessary to provide a power source harness for supplying power to the ECU 552, the ECU 554, the ECU 556, and the ECU 558, respectively. However, in this embodiment, by using the PoDL connectors according to the second embodiment of this disclosure, power can be supplied to the ECU 552, the ECU 554, the ECU 556, and the ECU 558 from the power source line 588 without the need to add these power source harnesses.

That is, the worker inserts a PoDL connector 590, a PoDL connector 592, a PoDL connector 594, and a PoDL connector 596 into the communication line 560, the communication line 562, the communication line 564, and the communication line 566, respectively, and connects third terminals thereof to the power source line 588 via a power line 598, a power line 600, a power line 602, and a power line 604, respectively.

The PoDL connector 590 has a function of converting 24-V DC power to 12 V. Both the PoDL connector 592 and the PoDL connector 594 have a function of converting 24-V DC power to 3.3 V. The PoDL connector 596 has a function of converting 24-V DC power to 5 V.

In this manner, by using the PoDL connectors according to the second embodiment, it is possible to supply DC power of different voltages to a plurality of ECUs from a single power source harness. There is no need for additional power source harnesses to supply power to each ECU.

### 2-4 Fourth Usage Mode (Multiple-Voltage Power Supply From Power Source)

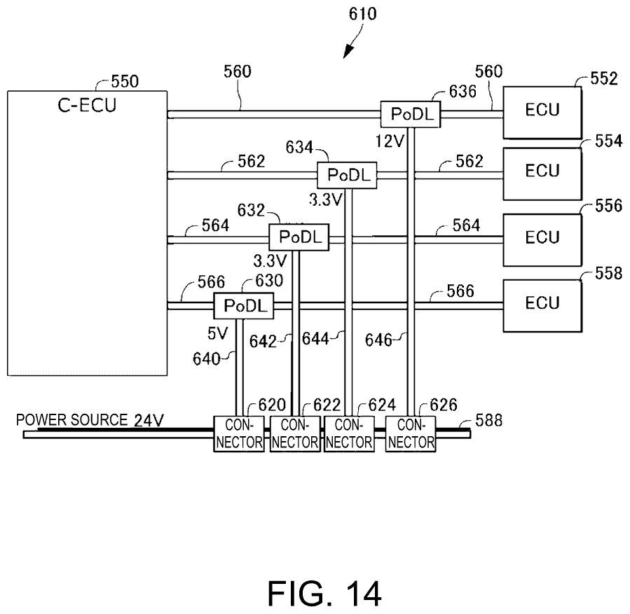

FIG. 14 shows a configuration of an in-vehicle system 610 capable of supplying DC power of different voltages to a plurality of ECUs by using a modified example of the PoDL connectors with voltage conversion functions according to the second embodiment. Referring to FIG. 14, the in-vehicle system 610 includes a C-ECU 550, an ECU 552, an ECU 554, an ECU 556, and an ECU 558, similar to those in FIG. 13 described above. Communication lines 560, 562, 564, and 566 are also similar to those in FIG. 13.

In this fourth usage mode, instead of the PoDL connector 590, the PoDL connector 592, the PoDL connector 594, and the PoDL connector 596 shown in FIG. 13, a PoDL connector 636, a PoDL connector 634, a PoDL connector 632, and a PoDL connector 630, which do not have voltage conversion functions, are used. In the fourth usage mode, furthermore, connectors 620, 622, 624, and 626, all of which are connected to the power source line 588 and have voltage conversion functions, are used. Third terminals of the PoDL connector 630, the PoDL connector 632, the PoDL connector 634, and the PoDL connector 636 are connected to third terminals of the connector 620, the connector 622, the connector 624, and the connector 626, respectively, by a power line 640, a power line 642, a power line 644, and a power line 646.

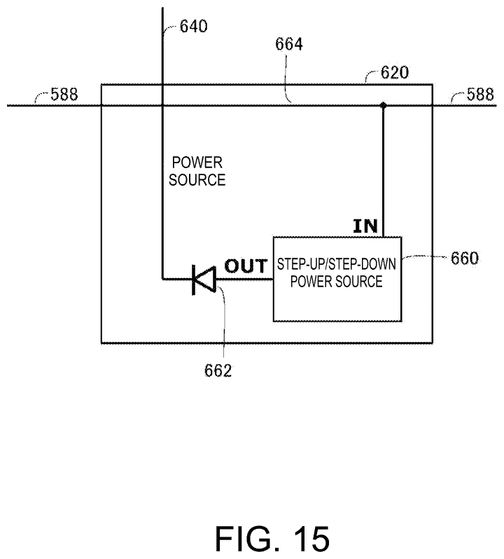

FIG. 15 shows, for example, a configuration of the connector 620 of FIG. 14. Referring to FIG. 15, the connector 620 includes an internal power source line 664 connected to the power source line 588, a step-up/step-down power source 660 that is a voltage conversion circuit having an input connected to the internal power source line 664, and a diode 662 inserted between the output of the step-up/step-down power source 660 and the power line 640 such that the direction of the diode 662 is the forward direction. In this example, the connector 620 converts 24-V DC power to 12 V. For this reason, the step-up/step-down power source 660 has a function of converting 24-V DC power to 12 V. That is, the step-up/step-down power source 660 and the diode 662 are for performing power exchange between the power source line 588 and the power line 640.

With this configuration, for example, the connector 620 converts the 24-V DC power of the power source line 588 to 5 V and outputs the result to the power line 640. The PoDL connector 630 superimposes this 5-V DC power on the data signal on the communication line 566. As a result, the ECU 558 is supplied with 5-V DC power via the communication line 566.

Similarly, the connector 622 converts the 24-V DC power of the power source line 588 to 3.3 V and outputs the result to the power line 642. The PoDL connector 632 superimposes this 3.3-V DC power on the data signal on the communication line 564. The connector 624 converts the 24-V DC power of the power source line 588 to 3.3 V and outputs the result to the power line 644. The PoDL connector 634 superimposes this 3.3-V DC power on the data signal on the communication line 562. The connector 626 converts the 24-V DC power of the power source line 588 to 12 V and outputs the result to the power line 646. The PoDL connector 636 superimposes this 12-V DC power on the data signal on the communication line 560.

As a result, even if the C-ECU 550 does not have a PoDL circuit, power can be supplied to the ECU 552, the ECU 554, the ECU 556, and the ECU 558 from the power source line 588 without an additional power source harness. Note that a connector that does not have PoDL functionality, such as the connector 620 in this embodiment, is also be used for power superimposition, and a connector system including the connector 629 and PoDL connector 630 and the power line 640 connecting them is also an example of a connector system for power superimposition according to this disclosure.

### 2-5 Fifth Usage (Power Supply by High Voltage Between Communication Lines)

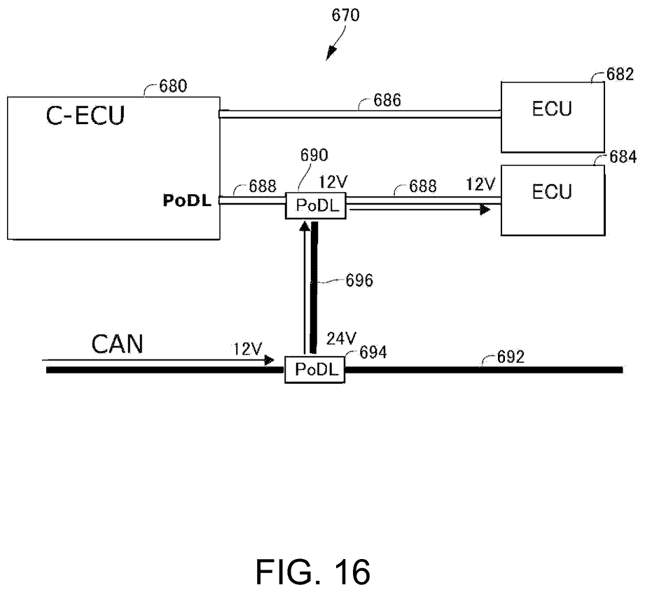

FIG. 16 shows a configuration of an in-vehicle system 670 according to a fifth usage mode of the PoDL connector according to the second embodiment. Referring to FIG. 16, the in-vehicle system 670 includes a C-ECU 680 that receives supply of power from a power source (not shown), and an ECU 682 and ECU 684 that are both connected to the C-ECU 680. The ECU 682 and the ECU 684 are connected to the C-ECU 680 by a communication line 686 and a communication line 688, respectively. No PoDL circuit is provided at the connection between the C-ECU 680 and the communication line 686. A PoDL circuit is provided at the connection between the C-ECU 680 and the communication line 688. The voltage of the DC power superimposed on the data signal on the communication line 688 is 12 V. The in-vehicle system 670 further includes a CAN 692, which is an in-vehicle network. It is assumed that 12-V DC power is superimposed on the data signal on the CAN 692 by PoDL.

In this example, it is assumed that the ECU 684 requires a large amount of power and the power received from the C-ECU 680 is insufficient. Here, to make up for this shortage, additional power is supplied to the ECU 684 from the CAN 692 via the communication line 688 by PoDL.

For this reason, the in-vehicle system includes a PoDL connector 694 that has a 12-V to 24-V step-up function and is inserted into the CAN 692, a PoDL connector 690 that has a 24-V to 12-V step-down function and is inserted into the communication line 688, and a power line 696 connecting a third terminal of the PoDL connector 694 and a third terminal of the PoDL connector 690.

In this configuration, the 12-V DC power superimposed on the CAN 692 is stepped up to 24 V by the PoDL connector 694 and then stepped down to 12 V by the PoDL connector 690. As a result, 12-V DC voltage is supplied to the ECU 684 via the communication line 688. Power can be supplied to the ECU 684 without the need for an additional power source harness for supplying power to the ECU 684. Since the voltage of the DC power is stepped up by the PoDL connector 694 before being supplied to the PoDL connector 690, the current can be made smaller than in the case where power is supplied at a lower voltage, which has the effect of being able to reduce heat generation.

### 3. Third Embodiment

The PoDL connector according to this disclosure can also be used to ensure redundant power sources in in-vehicle networks. Such a usage mode will be described below as a third embodiment.

### 3-1 First Usage Mode

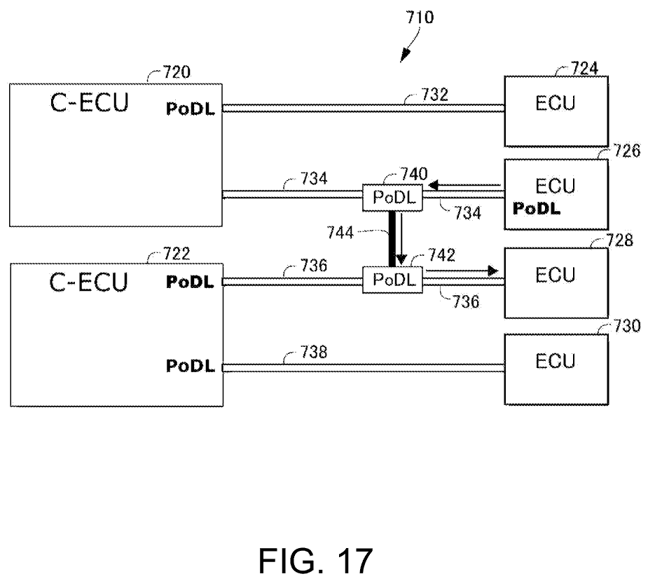

Referring to FIG. 17, an in-vehicle network 710 according to a first usage mode of the third embodiment includes a C-ECU 720 and a C-ECU 722, both of which receive supply of power from a power source not shown, as well as an ECU 724, an ECU 726, an ECU 728, and an ECU 730. The ECU 724 and the ECU 726 are connected to the C-ECU 720 via a communication line 732 and a communication line 734, respectively. The ECU 728 and the ECU 730 are connected to the C-ECU 722 via a communication line 736 and a communication line 738, respectively.

The C-ECU 720 has a PoDL circuit at the connection with the communication line 732. However, the ECU 730 does not have a PoDL circuit at the connection with the communication line 734. The C-ECU 722 has PoDL circuits at both the connection with the communication line 736 and the connection with the communication line 738. None of the ECU 724, the ECU 728, and the ECU 730 has a PoDL circuit, and all of them operate using power supplied from the C-ECU 720 or the C-ECU 722. However, the ECU 726 receives supply of power from an external source via an independent power source harness (not shown). The ECU 726 further has a PoDL circuit at the connection with the communication line 734 and has a function of superimposing DC power on a data signal on the communication line 734.

In this in-vehicle network 710, for example, when the ECU 726 is off (when the function is stopped), the ECU 726 does not use power. In this case, it is preferable to make it possible to supply the electric power supplied from the external source to the ECU 726 to another ECU (e.g., the ECU 728).

To this end, in this embodiment, a worker inserts the PoDL connector 740 into the communication line 734. The worker also inserts a PoDL connector 742 into the communication line 736. The worker further connects a third terminal of the PoDL connector 740 and a third terminal of the PoDL connector 742 with a power line 744. This allows power to be supplied from the ECU 726 to the ECU 728 via the communication line 734, the PoDL connector 740, the power line 744, the PoDL connector 742, and the communication line 736 when the ECU 726 is off. As a result, sufficient power is supplied to the ECU 728, allowing the ECU 728 to operate with a margin of safety. Alternatively, the supply of power from the C-ECU 722 to the ECU 728 can be stopped so that the ECU 728 operates using only power from the ECU 726. In this case, the C-ECU 722 need only supply power to the ECU 730, which has the effect of being able to provide the C-ECU 722 with more processing capability.

### 3-2 Second Usage Mode

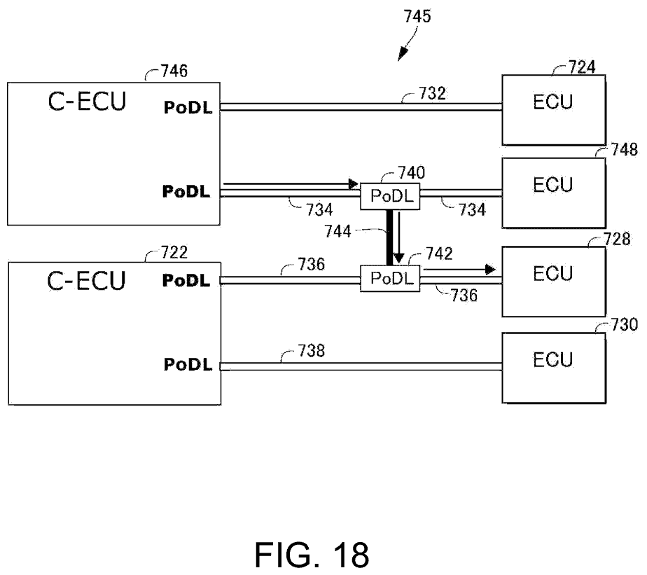

Referring to FIG. 18, an in-vehicle network 745 relating to a second usage mode of the third embodiment differs from the in-vehicle network 710 shown in FIG. 17 in that it includes a C-ECU 746 having a PoDL circuit in its portion communicating with the communication line 734 instead of the C-ECU 720 shown in FIG. 17, and in that it includes an ECU 748 not having a PoDL circuit instead of the ECU 726 shown in FIG. 17.

In the in-vehicle network 745 shown in FIG. 18, for example, when the ECU 724 or the ECU 748 is in sleep mode or off, the C-ECU 746 can supply surplus power to the ECU 728 via the path of the communication line 734, the PoDL connector 740, the power line 744, the PoDL connector 742, and the communication line 736. For this reason, the C-ECU 722 can stop the supply of power to the ECU 728 and set the in vehicle network 745 to a state in which it is sufficient to supply power only to the ECU 730.

### 3-3 Third Usage Mode

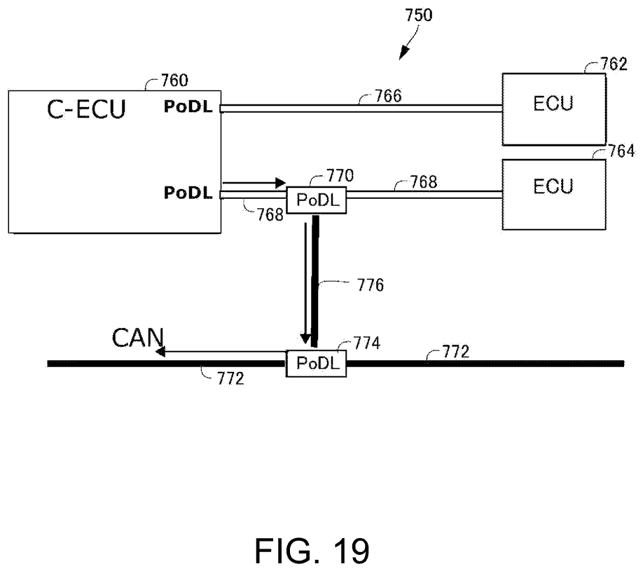

FIG. 19 shows the configuration of an in-vehicle network 750 according to a third usage mode of the third embodiment. Referring to FIG. 19, the in-vehicle network 750 includes a C-ECU 760, an ECU 762, and an ECU 764. The ECU 762 and the ECU 764 are connected to the C-ECU 760 by a communication line 766 and a communication line 768, respectively. The C-ECU 760 has PoDL circuits at both the connection with the communication line 766 and the connection with the communication line 768. Neither the ECU 762 nor the ECU 764 has a PoDL circuit. The in-vehicle network 750 further includes a CAN 772 that is an in-vehicle network.

This in vehicle network 750 further includes a PoDL connector 770 inserted into the communication line 768, a PoDL connector 774 inserted into the CAN 772, and a power line 776 connecting a third terminal of the PoDL connector 770 and a third terminal of the PoDL connector 774.

The PoDL connector 770 and the PoDL connector 774 may or may not have voltage conversion functions. The choice between these is determined by the relationship between the design voltage of the DC power superimposed on the communication line 768 and the design voltage of the DC power superimposed on the CAN 772.

According to this in-vehicle network 750, when the ECU 764 is off, instead of supplying power from the C-ECU 760 to the ECU 764, the power can be superimposed on the data signal on the CAN 772 via the path of the PoDL connector 770, the power line 776, and the PoDL connector 774. As a result, power can be supplied to other devices (not shown) that are set to receive supply of power from the CAN 772.

### 3-4 Fourth Usage Mode

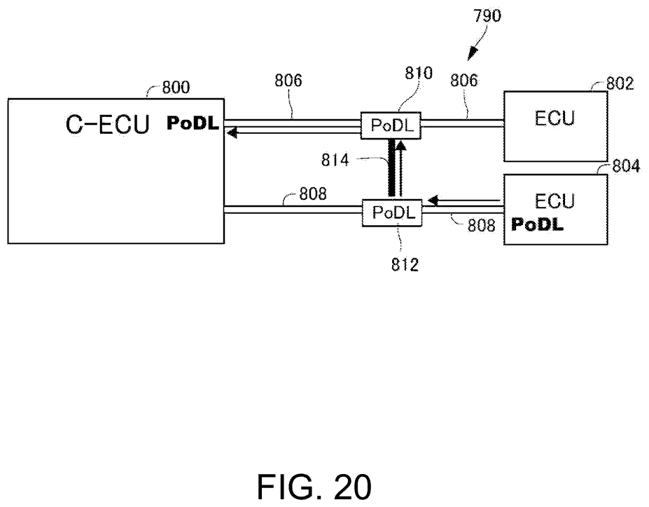

Referring to FIG. 20, an in vehicle system 790 according to a fourth usage mode of the third embodiment includes a C-ECU 800, an ECU 802, and an ECU 804. The C-ECU 800 receives supply of power from an external source via a power source line (not shown). The ECU 802 and the ECU 804 are connected to the C-ECU 800 via a communication line 806 and a communication line 808, respectively. The C-ECU 800 has a PoDL circuit at the connection with the communication line 806, and supplies DC power to the ECU 802 via the communication line 806. The ECU 802 operates using this DC power. However, the C-ECU 800 does not have a PoDL circuit at the connection with the communication line 808. The ECU 802 does not have a PoDL circuit. However, the ECU 804 has a PoDL circuit and operates by receiving power from a power source line (not shown).

In the in-vehicle system 790 having such a configuration, it is assumed that the power source line to the C-ECU 800 is disconnected for some reason. Normally, the C-ECU 800 will not operate unless the power source line is restored. However, in the case of a configuration such as that of the in-vehicle system 790, by using the PoDL connector according to this disclosure, it is possible to ensure a power source for the C-ECU 800 and restore the in-vehicle system 790 as follows.

That is, a worker inserts a PoDL connector 810 into the communication line 806 and a PoDL connector 812 into the communication line 808. The worker further connects a third terminal of the PoDL connector 810 and a third terminal of the PoDL connector 812 with the power line 814. As a result, power can be supplied from the ECU 804 to the C-ECU 800 via a path from the ECU 804 to the communication line 808, the PoDL connector 812, the power line 814, and the communication line 806. Thus, the PoDL connector 810, the CAN 812, and the power line 814 can ensure a redundant power source for the in-vehicle system 790. Accordingly, the in-vehicle system 790 can execute the minimum necessary functions.

Note that in this case as well, it is sufficient to determine whether to use a PoDL connector with a voltage conversion function or a PoDL connector without a voltage conversion function as the PoDL connector 812 and the PoDL connector 810 based on the operating voltage of the C-ECU 800, the voltage supplied from the ECU 804, and the like.

### 3-5 Fifth Usage Mode

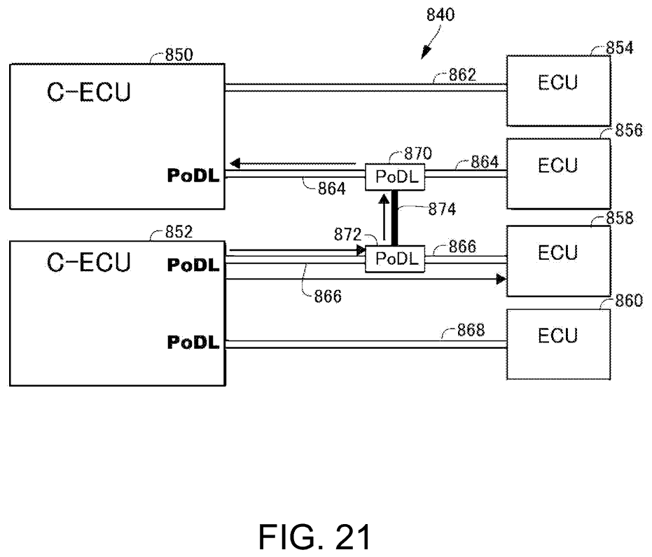

FIG. 21 shows the configuration of an in-vehicle system 840 according to a fifth usage mode of the third embodiment. Referring to FIG. 21, the in-vehicle system 840 includes a C-ECU 850, a C-ECU 852, an ECU 854, an ECU 856, an ECU 858, and an ECU 860. The ECU 854 and the ECU 856 are connected to the C-ECU 850 via a communication line 862 and a communication line 864, respectively. The ECU 858 and the ECU 860 are connected to the C-ECU 852 via a communication line 866 and a communication line 868, respectively. Both the C-ECU 850 and the C-ECU 852 receive power from the outside via a power source line (not shown).

The C-ECU 850 does not have a PoDL circuit at the connection with the communication line 862. However, the C-ECU 850 has a PoDL circuit at the connection with the communication line 864. The ECU 854 operates with power supplied from an external source via a power source line (not shown). The ECU 856 operates using power supplied from the C-ECU 850 via the communication line 864, Note that neither the ECU 854 nor the ECU 856 has a PoDL circuit.

The C-ECU 852 has PoDL circuits at both the connection with the communication line 866 and the connection with the communication line 868. The ECU 858 and the ECU 860 operate using DC power supplied from the C-ECU 852 via the communication line 866 and the communication line 868, respectively.

In this in vehicle system 840, if the power source line that supplies power to the C-ECU 850 is disconnected, the C-ECU 850 stops operating. Normally, unless the power source line is restored, the C-ECU 850 does not operate and the in-vehicle system 840 cannot perform its normal functions. By using the PoDL connector according to this disclosure, it is possible to ensure a power source for the C-ECU 850 as follows, and enable the in-vehicle system 840 to function, albeit temporarily.

That is, a worker inserts a PoDL connector 870 into the communication line 864 as shown in FIG. 21. The worker also inserts a PoDL connector 872 into the communication line 866. The worker further connects a third terminal of the PoDL connector 870 and a third terminal of the PoDL connector 872 with a power line 874.

When such a connection is made, power can be supplied to the C-ECU 850 from the C-ECU 852 via the path of the communication line 866, the PoDL connector 872, the power line 874, the PoDL connector 870, and the communication line 864. As a result, the C-ECU 850 can resume operation. Accordingly, the in-vehicle system 840 can execute overall functions, albeit temporarily.

### 3-6 Sixth Usage Mode

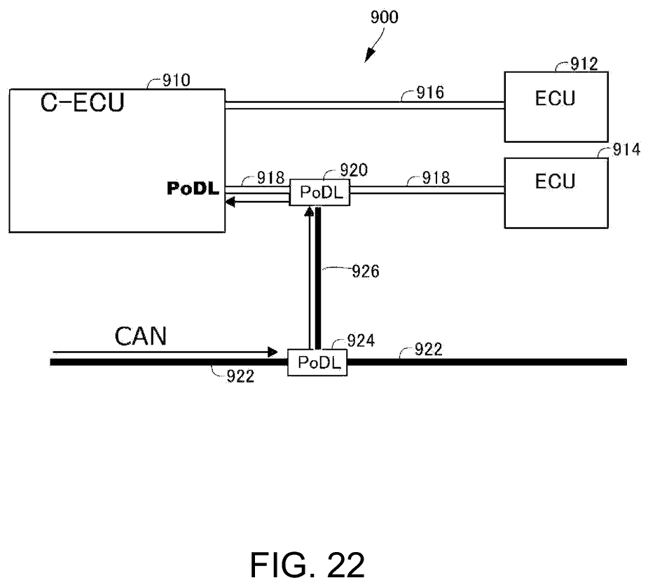

FIG. 22 shows a configuration of an in-vehicle system 900 according to a sixth usage mode of the third embodiment of this disclosure. Referring to FIG. 22, the in-vehicle system 900 includes a C-ECU 910, an ECU 912, and an ECU 914. The in-vehicle system 900 further includes a CAN 922 serving as an in-vehicle network. The C-ECU 910 receives power from an external source via a power source line (not shown).

The ECU 912 and the ECU 914 are connected to the C-ECU 910 by a communication line 916 and a communication line 918, respectively. The C-ECU 910 does not have a PoDL circuit at the connection with the communication line 916. However, the C-ECU 910 has a PoDL circuit at the connection with the communication line 918. Accordingly, the ECU 912 operates by receiving supply of power from an external source via a power source line (not shown), and the ECU 914 operates by receiving supply of power from the C-ECU 910 via PoDL.

DC power from another device (not shown) is superimposed on the data signal on the CAN 922.

In this in-vehicle system 900, a case will be considered in which a power source line that supplies power to the C-ECU 910 is disconnected. Normally, the C-ECU 910 stops operating, and the in-vehicle system 900 cannot perform its functions. By using the PoDL connector according to this disclosure, the in-vehicle system 900 can be operated, albeit temporarily, as described below, and the functions of the in-vehicle system 900 can be realized.

That is, a worker inserts a PoDL connector 920 into the communication line 918. The worker inserts a PoDL connector 924 into the CAN 922. The worker further connects a third terminal of the PoDL connector 920 and a third terminal of the PoDL connector 924 with a power line 926. By making such a connection, the DC power superimposed on the data signal on the CAN 922 can be supplied to the C-ECU 910 via the path of the PoDL connector 924, the power line 926, the PoDL connector 920, and the communication line 918. As a result, the C-ECU 910 can be started up, and all the functions of the in-vehicle system 900 can be realized, albeit temporarily.

Note that in this embodiment as well, whether to use PoDL connectors with voltage conversion functions or PoDL connectors without voltage conversion functions as the PoDL connectors 924 and 920 is determined based on the voltage of the DC power superimposed on the data signal on the power line 916 and the voltage of the DC power superimposed on the data signal on the CAN 922.

### 3-7 Seventh Usage Mode

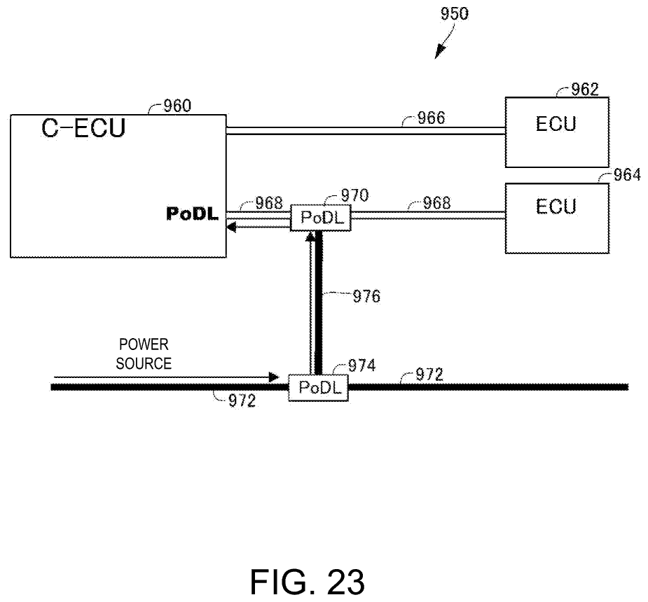

FIG. 23 shows a configuration of an in-vehicle system 950 according to a seventh usage mode of the third embodiment of this disclosure. Referring to FIG. 23, the in-vehicle system 950 includes a C-ECU 960, an ECU 962, and an ECU 964. The C-ECU 960 is supplied with power from an external source via a power source line (not shown). The ECU 962 and the ECU 964 are connected to the C-ECU 960 by a communication line 966 and a communication line 968, respectively. The C-ECU 960 does not have a PoDL circuit at the connection with the communication line 966. The C-ECU 962 operates by obtaining power from an external source via an independent power source line (not shown). However, the C-ECU 960 has a PoDL circuit at the connection with the communication line 968. The ECU 964 operates using power supplied from the C-ECU 960 via the communication line 968. The in-vehicle system 950 further includes a power source line 972.

A case is assumed in which the power source line to the C-ECU 960 is disconnected in this configuration. The C-ECU 960 stops operating, and the in-vehicle system 950 also stops functioning. However, power can be supplied to the C-ECU 960 by using a PoDL connector according to this disclosure, as described below.

A worker inserts a PoDL connector 970 into the communication line 968. The worker inserts a PoDL connector 974 into the power source line 972. The worker further connects a third terminal of the PoDL connector 970 and a third terminal of the PoDL connector 974 with a power line 976. In this way, power is supplied to the C-ECU 960 by PoDL via the path of the power source line 972, the PoDL connector 974, the power line 976, the PoDL connector 970, and the communication line 968. Accordingly, the in-vehicle system 950 is also restored.

### 3-8 Eighth Usage Mode

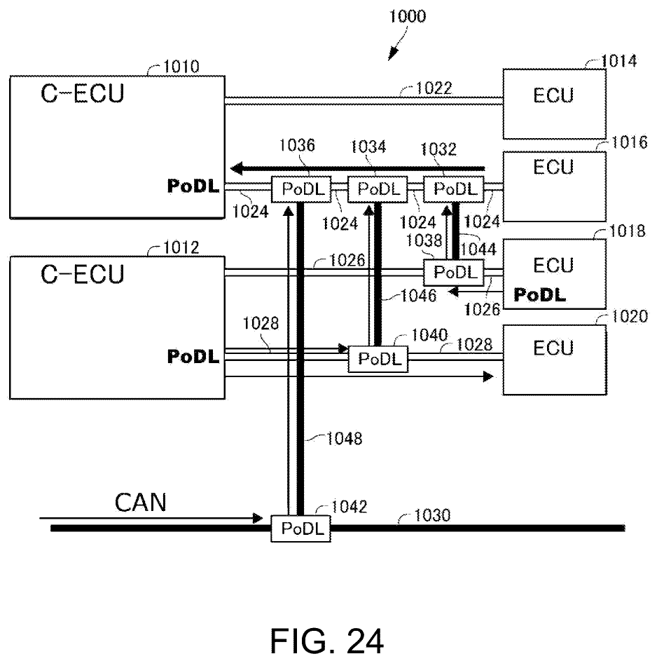

FIG. 24 shows the configuration of an in-vehicle system 1000 using a PoDL connector according to this disclosure. Referring to FIG. 24, the in-vehicle system 1000 includes a C-ECU 1010, a C-ECU 1012, an ECU 1014, an ECU 1016, an ECU 1018, an ECU 1020, and a CAN 1030 that is an in-vehicle network. DC power is superimposed on the data signal on the CAN 1030 by a device not shown.

The ECU 1014 and the ECU 1016 are connected to the C-ECU 1010 via a communication line 1022 and a communication line 1024, respectively. The C-ECU 1010 does not have a PoDL circuit at the connection with the communication line 1022. The ECU 1014 operates by receiving supply of power from an external source via a power source line (not shown). The C-ECU 1010 has a PoDL circuit at the connection with the communication line 1024. The ECU 1016 operates by receiving supply of DC power supplied by PoDL from the C-ECU 1010 via the communication line 1024.

The ECU 1018 and the ECU 1020 are connected to the C-ECU 1012 via a communication line 1026 and a communication line 1028, respectively. The C-ECU 1012 does not have a PoDL circuit at the connection with the communication line 1026. The ECU 1018 operates by receiving supply of power from an external source via a power source line (not shown). The C-ECU 1012 has a PoDL circuit at the connection with the communication line 1028. The ECU 1020 operates by receiving supply of DC power supplied by PoDL from the C-ECU 1012 via the communication line 1028.

For example, a case is assumed in which the power source line of the C-ECU 1010 is disconnected in this configuration. For example, as in the example shown in FIG. 21, it is also possible to supply power from the ECU 1018 to the C-ECU 1010 by inserting a PoDL connector 1032 and a PoDL connector 1038 into the communication line 1024 and the communication line 1026, respectively, and connecting third terminals thereof with a power line 1044. However, when the power required for the operation of the C-ECU 1010 is large, this alone may not be sufficient. In the example shown in FIG. 24, sufficient power is supplied to the C-ECU 1010 as follows.

Referring to FIG. 24, in this example, in addition to the PoDL connector 1032 and the PoDL connector 1038, the worker inserts a PoDL connector 1034, a PoDL connector 1040, a PoDL connector 1036, and a PoDL connector 1042 into the communication line 1024, the communication line 1028, the communication line 1024, and the CAN 1030, respectively. The worker connects a third terminal of the PoDL connector 1034 and a third terminal of the PoDL connector 1040 with a power line 1046. The worker further connects a third terminal of the PoDL connector 1036 and a third terminal of the PoDL connector 1042 with a power line 1048.

Note that in the above embodiment, it is assumed that the voltages superimposed on the communication lines are equal. However, this disclosure is not limited to such embodiments. For example, the DC voltage to be superimposed on the communication line 1024 may not match the DC voltage superimposed on the electrical signal on the communication line 1026. In such a case, in this embodiment, at least one of the PoDL connector 1038 and the PoDL connector 1032 may be provided with a voltage conversion function. The same applies also to the case where power is supplied from the communication line 1028 and the CAN 1030 to the communication line 1024. In other words, when the voltage of the power supply source does not match the voltage of the power supply destination, at least one of the PoDL connector 1040 and the PoDL connector 1034 and at least one of the PoDL connector 1042 and the PoDL connector 1036 need to have voltage conversion functions. In addition, if the voltage is stepped up and then branched off to another communication line as shown in FIG. 16 as a measure against heat, each PoDL connector needs to have a voltage conversion function.

By arranging the PoDL connectors in this manner, the ECU 1018 supplies DC power to the C-ECU 1010 via the communication line 1026, the PoDL connector 1038, the power line 1044, the PoDL connector 1032, and the communication line 1024. The C-ECU 1012 supplies DC power to the C-ECU 1010 via the communication line 1028, the PoDL connector 1040, the power line 1046, the PoDL connector 1034, and the communication line 1024. The CAN 1030 supplies DC power to the C-ECU 1010 via the PoDL connector 1042, the power line 1048, the PoDL connector 1036, and the communication line 1024. As a result, the C-ECU 1010 is supplied with sufficient power from the ECU 1018, the C-ECU 1012 and the CAN 1030. Accordingly, the C-ECU 1010 can operate normally.

As described above, the PoDL connector according to this disclosure makes it easy to perform a change in which, in the design stage of an in-vehicle system, supply of DC power from the PoDL circuit of another device is received when there is a power shortage for an electronic circuit such as an ECU in the in vehicle system. For example, even if a higher performance ECU is used during the design stage, the power required for the ECU to operate can be ensured without making changes to other portions of the in-vehicle system. As a result, the degree of freedom in design can be increased.

According to the PoDL connector disclosed herein, even when the supply of power to the power source lines of some ECUs is cut off or insufficient during operation of the in-vehicle system, a power source can be ensured with a simple task without changing the configuration of another portion. As a result, the degree of freedom in design is increased and the maintainability of the in-vehicle system during operation is improved.

Note that in the description of the above embodiment, the PoDL connector was described as being separate from the power line. However, this disclosure is not limited to such embodiments. This disclosure may also be implemented as a product in which a power line is connected to a third terminal of a PoDL connector. Furthermore, this disclosure may also be implemented as a product in which the third terminals of a pair of PoDL connectors are connected in advance with a power line. As is apparent from the above discussion as well, in many cases, a pair of PoDL connectors are used simultaneously. Accordingly, by connecting such a pair to each other in advance, operations such as power source restoration can be easily performed. In this case, neither of the pair may have a voltage conversion function, only one of the pair may have a voltage conversion function, or both of the pair may have a voltage conversion function. If the device has a voltage conversion function, the voltage values before and after the conversion are automatically determined according to the design of the in vehicle system and the position where the PoDL connector is installed.

### 4. Fourth Embodiment

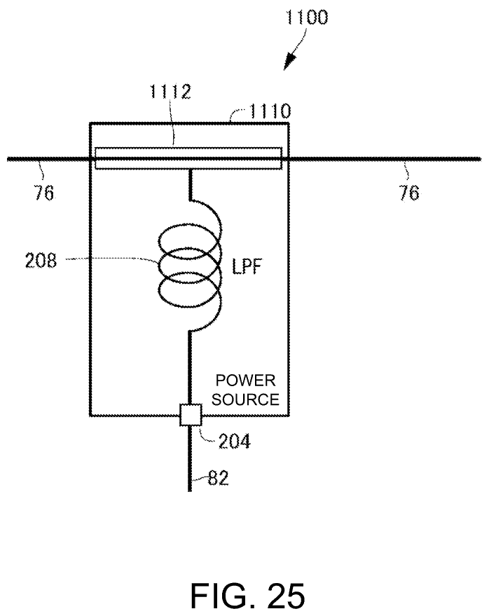

FIG. 25 shows a schematic configuration of a PoDL connector 1100 according to the fourth embodiment of this disclosure. This PoDL connector 1100 differs from the PoDL connector 80 shown in FIG. 2 in that instead of having two connection terminals 200 and 202 like the first connection portion 210 in FIG. 2, the PoDL connector 1100 includes a first connection portion 1112 constituted by a metal terminal plate that is provided such that its entirety is in contact with the communication line 76 and is electrically coupled to communication line 76. In this case, the coating of the communication line 76 may also be removed. The PoDL connector 1100 also includes a housing 1110 having a structure for sandwiching the communication line 76 to bring the first connection portion 1112 and the communication line 76 into favorable contact with each other. One end of the low pass filter 208 is connected to the first connection portion 1112. In this embodiment, the low-pass filter 208 also functions to exchange power between the communication line 76 and the power line 82.

With the PoDL connector 1100 according to the fourth embodiment, the communication line 76 is sandwiched between the housing 1110, whereby the PoDL connector 1100 can be easily attached to the communication line 76. As a result, not only can the degree of freedom in designing the in-vehicle system be increased, but also power distribution paths can be easily constructed according to actual conditions.

Each process (each function) in the above-described embodiments is realized by a processing circuit (circuitry) including one or more processors. The above-described processing circuit may also be constituted by an integrated circuit combining one or more memories, various analog circuits, and various digital circuits in addition to the one or more processors. The one or more memories store programs (commands) for causing the one or more processors to execute each of the above processes. The one or more processors may execute each of the above processes according to the program read from the one or more memories, or may execute each of the above processes according to a logic circuit designed in advance to execute each of the above processes. The processor may be any of a variety of processors suitable for computer control, such as a Central Processing Unit (CPU), a Graphics Processing Unit (GPU), a Digital Signal Processor (DSP), a Field-Programmable Gate Array (FPGA), or an Application Specific Integrated Circuit (ASIC). Note that the plurality of physically separated processors may cooperate with each other to execute the above processes. For example, the above-mentioned processors mounted on each of a plurality of physically separated computers may cooperate with each other via a network such as a Local Area Network (LAN), a Wide Area Network (WAN), or the Internet to execute the above-mentioned processes. The program may also be installed in the memory from an external server device or the like via the network, or may be distributed in a state stored on a recording medium such as a Compact Disc Read-Only Memory (CD-ROM), a Digital Versatile Disc (DVD)-ROM, or a semiconductor memory, and installed in the memory from the recording medium.

The embodiments disclosed herein are illustrative in all respects and are not restrictive. The scope of the present disclosure is indicated not by the detailed description of the disclosure, but by each claim in the claims, and is intended to include all modifications within the meaning and scope equivalent to the wording of the claims.

1. A power superimposition connector comprising:
a housing having a first connection electrically coupled to a communication line configured to carry an electrical signal, and a second connection; and
a power exchange circuit that is connected to the first connection and the second connection, is provided within the housing, and is configured to perform exchange between power superimposed on an electrical signal on the communication line and power on a power line connected to the second connection, between the first connection and the second connection.

2. The power superimposition connector according to claim 1,
wherein the power superimposed on the electrical signal on the communication line is DC power.

3. The power superimposition connector according to claim 2,
wherein the power exchange circuit includes a low-pass filter.

4. The power superimposition connector according to claim 2,
wherein the power exchange circuit includes:
a low-pass filter having a first connection terminal connected to the first connection, and a second connection terminal; and
a voltage conversion circuit provided between the second connection terminal of the low-pass filter and the second connection.

5. The power superimposition connector according to claim 1, wherein:
the first connection includes:
a first connection terminal and a second connection terminal each electrically coupled to the communication line; and
an internal communication line provided within the housing, the internal communication line connecting the first connection terminal and the second connection terminal, and
the power exchange circuit is provided between the internal communication line and the second connection.

6. A power distribution method for distributing power using a power superimposition connector that includes: a housing having a first connection and a second connection each electrically coupled to a communication line configured to carry an electrical signal on which DC power is superimposed; and a power exchange circuit that is connected to the first connection and the second connection, is provided within the housing, and is configured to perform exchange of power between the first connection and the second connection, the method comprising:
connecting the first connection to a first communication line;
connecting the second connection to a power line different from the first communication line;
extracting the power from the communication line via the first connection; and
converting, using the power exchange circuit, the power extracted into power superimposed on an electrical signal on the power line via the second connection.

7. A power superimposition connector system comprising:
a first power superimposition connector;
a second power superimposition connector, wherein each of the first power superimposition connector and the second power superimposition connector includes the power superimposition connector according to claim 1;
a power line connected to the second connection of the first power superimposition connector and the second connection of the second power superimposition connector.

8. The power superimposition connector system according to claim 7, wherein:
the first connection of the first power superimposition connector is connected to a first communication line carrying an electrical signal on which DC power is superimposed, branches at least a portion of the DC power from the first communication line, and outputs the branched DC power to the power line, and
the first connection of the second power superimposition connector is connected to a second communication line carrying an electrical signal on which DC power is superimposed, receives the branched DC power from the first power superimposition connector via the power line, and superimposes the branched DC power on the electrical signal on the second communication line.

9. The power superimposition connector system according to claim 8,
wherein at least one of the first communication line and the second communication line is a network.

10. The power superimposition connector system according to claim 8,
wherein at least one of the first communication line and the second communication line is a power source line.

11. The power superimposition connector system according to claim 8, wherein:
the first communication line is connected to a first electronic circuit and a second electronic circuit, and
the second communication line is connected to the first electronic circuit and a third electronic circuit that is different from both the first electronic circuit and the second electronic circuit.

12. The power superimposition connector system according to claim 8, wherein:
the first communication line connects a first electronic circuit and a second electronic circuit, and
the second communication line is connected to a third electronic circuit and a fourth electronic circuit that are both different from both the first electronic circuit and the second electronic circuit.

13. The power superimposition connector system according to claim 8,
wherein the second communication line is a communication line in which, other than the branched DC power superimposed by the second power superimposition connector, DC power is not superimposed on an electrical signal.

14. A power distribution system comprising:
a first power superimposition connector system;
a second power superimposition connector system, wherein:
each of the first power superimposition connector system and the second power superimposition connector system includes the power superimposition connector system according to claim 7,
the first power superimposition connector system is connected to a first communication line and a second communication line on which DC power can be superimposed, and
the second power superimposition connector system is connected between a third communication line that is different from both the first communication line and the second communication line, and the second communication line.

15. The power distribution system according to claim 14, wherein:
the first power superimposition connector system branches a portion of the DC power superimposed on the electrical signal on the first communication line and superimposes the branched DC power on the electrical signal on the second communication line, and
the second power superimposition connector system branches a portion of the DC power superimposed on the electrical signal on the third communication line and superimposes the branched DC power on the electrical signal on the second communication line.

16. The power distribution system according to claim 14, wherein:
the first power superimposition connector system branches a portion of the DC power superimposed on the electrical signal on the second communication line and superimposes the branched DC power on the electrical signal on the first communication line, and
the second power superimposition connector system branches a portion of the DC power superimposed on the electrical signal on the second communication line and superimposes the branched DC power on the electrical signal on the third communication line.

17. A power superimposition connector system comprising:
a first power superimposition connector; and
second power superimposition connector, wherein:
each of the first power superimposition connector and the second power superimposition connector includes the power superimposition connector according to claim 4,
the voltage conversion circuit of the first power superimposition connector includes a step-up circuit for stepping up from a predetermined first voltage to a second voltage that is higher than the first voltage, and
the voltage conversion circuit of the second power superimposition connector includes a step-down circuit for stepping down from the second voltage to a third voltage that is lower than the second voltage.

18. The power superimposition connector system according to claim 17,
wherein the third voltage is equal to the first voltage.

9. The power superimposition connector system according to claim 17,
wherein the third voltage is different from the first voltage.

20. A power distribution system comprising:
a first power superimposition connector system including a first power superimposition connector and a second power superimposition connector; and
a second power superimposition connector system including a third power superimposition connector and a fourth power superimposition connector, wherein:
each of the first power superimposition connector, the second power superimposition connector, the third power superimposition connector and the fourth power superimposition connector includes the power superimposition connector according to claim 1,
power exchange circuit in at least one of the first power superimposition connector and the second power superimposition connector and the power exchange circuit in at least one of the third power superimposition connector and the fourth power superimposition connector has a low-pass filter having a first connection terminal connected to the first connection, and a second connection terminal; and a voltage conversion circuit provided between the second connection terminal of the low-pass filter and the second connection,
the first power superimposition connector of the first power superimposition connector system is connected to a first communication line,
the second power superimposition connector of the first power superimposition connector system is connected to a second communication line different from the first communication line,
the third power superimposition connector of the second power superimposition connector system is connected to a third communication line different from the first communication line and the second communication line,
the fourth power superimposition connector of the second power superimposition connector system is connected to the second communication line,
the first power superimposition connector system branches DC power of a first voltage that is superimposed on an electrical signal on the first communication line, converts the branched DC power to a second voltage, and superimposes the result on an electrical signal on the second communication line, and
the second power superimposition connector system branches DC power of a third voltage that is superimposed on an electrical signal on the third communication line, converts the branched DC power to the second voltage, and superimposes the result on the electrical signal on the second communication line.

21. The power distribution system of claim 20,
wherein the first voltage and the third voltage are different from each other.

22. The power distribution system of claim 20,
wherein the first voltage and the third voltage are equal to each other,

23. A power distribution system comprising:
a first power superimposition connector system including a first power superimposition connector and a second power superimposition connector; and
a second power superimposition connector system including a third power superimposition connector and a fourth power superimposition connector, wherein:
each of the first power superimposition connector, the second power superimposition connector, the third power superimposition connector and the fourth power superimposition connector includes the power superimposition connector according to claim 1,
the power exchange circuit in at least one of the first power superimposition connector and the second power superimposition connector and the power exchange circuit in at least one of the third power superimposition connector and the fourth power superimposition connector has a low-pass filter having a first connection terminal connected to the first connection, and a second connection terminal; and a voltage conversion circuit provided between the second connection terminal of the low-pass filter and the second connection,
the first power superimposition connector of the first power superimposition connector system is connected to a first communication line,
the second power superimposition connector of the first power superimposition connector system is connected to a second communication line different from the first communication line,
the third power superimposition connector of the second power superimposition connector system is connected to the first communication line,
the fourth power superimposition connector of the second power superimposition connector system is connected to a third communication line different from the first communication line and the second communication line,
the first power superimposition connector system branches DC power of a first voltage that is superimposed on an electrical signal on the first communication line, converts the branched DC power to a second voltage, and superimposes the result on an electrical signal on the second communication line, and
the second power superimposition connector system branches DC power of the first voltage that is superimposed on the electrical signal on the first communication line, converts the branched DC power to a third voltage, and superimposes the result on an electrical signal on the third communication line.

24. The power distribution system according to claim 23,
wherein the second voltage and the third voltage are different from each other.

25. The power distribution system according to claim 23,
wherein the second voltage and the third voltage are equal to each other.

26. The power distribution system according to claim 14, further comprising:
a first electronic circuit device connected to the first communication line; and
a second electronic circuit device connected to the first communication line.
